(19) United States
(12) Patent Application Publication
(10) Pub. No.: US 2023/0410102 A1
(43) Pub. Date: Dec. 21, 2023

(54) BLOCKCHAIN

(71) Applicant: Cambridge Cryptographic Ltd, London (GB)

(72) Inventors: John FLETCHER, London (GB); Ying CHAN, Cambridge (GB)

(73) Assignee: Cambridge Cryptographic Ltd, London (GB)

(21) Appl. No.: 18/031,385

(22) PCT Filed: Oct. 12, 2021
(86) PCT No.: PCT/GB2021/052639

§ 371 Date: Apr. 12, 2023

(30) Foreign Application Priority Data
Oct. 12, 2020 (GB) 2016186.5
Mar. 8, 2021 (EP) 21161346.8
Jun. 17, 2021 (GB) 2108692.1

(51) Int. Cl. G06Q 20/38; H04L 9/32; H04L 9/00

(52) U.S. Cl. CPC G06Q 20/389; G06Q 2220/00; H04L 9/50; H04L 9/3247

(57) ABSTRACT

There is described a computer-implemented method of outputting a transmission to a second node of a blockchain, the method being performed by a first node of the blockchain, the method comprising: determining a computational power devoted by a further node to a blockchain; determining, based on the determined computational power, a parameter relating to: the influence of the further node on a consensus mechanism of the blockchain; and/or a reward for the further node; and outputting a transmission to the second node of the blockchain in dependence on the parameter.

### FIELD OF INVENTION

The present invention relates to a computer-implemented method, in particular a computer-implemented method of outputting a transmission to a node of a blockchain. The invention further relates to a method of configuring a blockchain and an apparatus and system for accessing and/or viewing the blockchain.

### BACKGROUND

A blockchain is an electronic ledger on which data can be stored. Specifically, a blockchain comprises a plurality of blocks, with each block containing its own list of one or more records. Each block also contains a reference to (e.g. a cryptographic hash of) the previous block so that there exists an unbroken link running through the entirety of the blockchain, with each block referring to the preceding block. Modifying any of the constituent blocks of the blockchain affects the cryptographic hash, so that any modification of a past block is immediately apparent.

Each block of the blockchain comprises a number of records, where each block typically comprises transactions between entities on the blockchain. In order for a transaction to be included in a block and added to the blockchain this transaction must be verified. Verification comprises checking that the transaction meets certain requirements. As an example, in typical implementations of blockchains an amount of a digital asset is locked based on a public key; in order to unlock and spend this digital asset an entity must provide proof that they hold a corresponding private key. The testing of this proof forms a part of the verification process, where a transaction relating to the locked digital asset will not be verified until the requisite proof is provided. Once the transaction has been verified it can be included in a block which is proposed, e.g. by a miner, for addition to the blockchain. This block can then be propagated throughout the system where it is validated (e.g. the validity of the transactions and the mining process is confirmed) by further nodes.

When a party wishes to add a block to the blockchain, a consensus mechanism is typically used to build a consensus on the history of the blockchain. The consensus mechanism may comprise a dynamic membership multi-signature (DMMS) that is recorded on the blockchain. In a proof of work blockchain, such as Bitcoin, the DMMS typically comprises signatures of computational power (SoCPs); in a proof of stake blockchain, such as Algorand, the DMMS typically comprises signatures of knowledge (SoKs).

Signatures of computational power typically comprise evidence that a user is devoting a certain amount of computing power to a network; this may be demonstrated by the user solving a certain cryptographic problem.

Signatures of knowledge typically comprise evidence that a user controls an amount of an asset on a network (e.g. a certain amount of a cryptocurrency relating to a blockchain). The signatures may comprise a number of blockchain addresses. Typically, the signatures of knowledge evidence knowledge of a private key that corresponds to a public key, which public key controls an amount of an asset relating to the blockchain.

Signatures of computational power and signatures of knowledge are further described in “Back et. Al Enabling Blockchain Innovations with Pegged Sidechains. 2014; https://blockstream.com/sidechains.pld”.

The DMMS typically relates to each party that is involved in the addition of a block to the blockchain, e.g. in Bitcoin the DMMS relates to the miners of Bitcoin and in Algorand the DMMS relates to the holders of a deposit.

In order to add a block to the blockchain, the stakeholders must reach consensus on an appropriate block. Problematically, if consensus were to be reached based on a vote between contributors, the blockchain would be open to a sybil attack, where a malicious actor could run multiple nodes on the blockchain and thereby outvote the other, legitimate, nodes.

In order to hinder such sybil attacks, blockchains typically further comprise an anti-sybil mechanism and/or a sybil-defence mechanism. This sybil-defence mechanism controls the influence that a party has on the consensus mechanism and thereby prevents a malicious actor taking control of the network by running multiple nodes. Examples of anti-sybil mechanisms include:
Proof of Work (PoW). With a proof of work sybil-defence mechanism, the degree of influence that a node has on the consensus mechanism is dependent on an amount of computational work performed by that node.
Typically, the computational work performed by each node is determined by requiring nodes of the blockchain to solve cryptographic problems, where a node finding a solution for the problems indicates that this node has performed a certain amount of computational work. Exemplary cryptographic problems include: finding a solution that results in a certain hash (e.g. finding a nonce that can be hashed with a block to give a hash with a certain number of leading zeros); and finding a solution for a verifiable delay function.
This sybil-defence mechanism prevents a party from increasing their influence by splitting their computing power over multiple nodes,
An exemplary blockchain that uses a proof of work sybil-defence mechanism is Bitcoin, which is described in detail in “Satoshi Nakamoto. Bitcoin: A peer-to-peer electronic cash system. http://nakamotoinstitute.org/bitcoin/(2008)”.
Proof of Stake (PoS). With a proof of stake sybil-defence mechanism, the degree of influence that a node has on the consensus mechanism is dependent on a deposit held by that party.
This sybil-defence mechanism hinders sybil attacks by requiring any attacker to hold a large stake in the blockchain (e.g. a malicious actor cannot increase their influence on the consensus mechanism by splitting a small stake over a large number of nodes).
An exemplary blockchain that uses a proof of stake system is Algorand, which is described in “Silvio Micali. Algorand: the efficient and democratic ledger. CoRR, abs/1607.01341, 2016”

### SUMMARY OF THE DISCLOSURE

Aspects and embodiments of the present invention are set out in the appended claims. These and other aspects and embodiments of the invention are also described herein.

Single Blockchain

According to least one aspect of the present disclosure, there is described a computer-implemented method of outputting a transmission to a second node of a blockchain, the method being performed by a first node of the blockchain, the method comprising: determining a computational power devoted by a further node to a blockchain; determining, based on the determined computational power, a parameter relating to: the influence of the further node on a consensus mechanism of the blockchain; and/or a reward for the further node; and outputting a transmission to the second node of the blockchain in dependence on the parameter.

Preferably, the parameter relates to the eligibility of the further node to participate in the building of a consensus and/or the addition of a block.

Preferably, determining a parameter comprises determining one or more nodes that are eligible to participate in the building of a consensus and/or the addition of a block.

Preferably, determining the parameter comprises determining an eligibility to be selected to participate of the further node in the addition of a block to the blockchain.

Preferably, determining the parameter comprises determining a probability of selection to participate of the further node in the addition of a block to the blockchain.

Preferably, determining the parameter comprises determining a maximum degree of active participation of the further node in the addition of a block to the blockchain.

Preferably, the parameter relates to a reward for the further node, the reward relating to the addition of the block to the blockchain.

Preferably, determining a parameter comprises determining a reward for the further node, the reward relating to the addition of the block to the blockchain.

Preferably, the parameter relates to a probability of the further node being selected as a participant in the addition of a block.

Preferably, determining a parameter comprises determining a probability of the further node being selected as a participant in the addition of a block.

Preferably, the parameter relates to a degree of eligibility to be selected to participate of the further node in the addition of the block.

Preferably, determining a parameter comprises determining a degree of eligibility to be selected to participate of the further node in the addition of the block.

Preferably, the parameter relates to a maximum degree of active participation of the further node in the addition of the block.

Preferably, determining a parameter comprises determining a maximum degree of active participation of the further node in the addition of the block.

Preferably, the parameter relates to a weighting for a contribution to the building of consensus for the further node.

Preferably, determining a parameter comprises determining a weighting for a contribution to the building of consensus for the further node.

Preferably, the weighting comprises a weighting for a representation of the further node in a dynamic-membership multi-signature (DMMS).

Preferably, the method comprises determining a reward for one or more nodes eligible to be selected to participate in the building of a consensus and/or the addition of a block.

Preferably, the method comprises determining a reward for each of the eligible nodes.

Preferably, each eligible node receives a reward.

Preferably, the method comprises designating and/or selecting the further node as a participant in the addition of the block to the blockchain, preferably designating and/or selecting the further node as a proposer and/or validator of the block.

Preferably, the further node comprises the second node and/or a the further node comprises a third node of the blockchain.

Preferably, the parameter is dependent on at least one further sybil-defence mechanism. Preferably, the further sybil-defence mechanism is associated with proof of work and/or proof of stake.

Preferably, the block is a future block of the blockchain. Preferably, the block is the next block of the blockchain.

Preferably, outputting a transmission comprises indicating the further node as being an eligible participant in the addition of a block to the blockchain.

Preferably, outputting a transmission comprises indicating a reward for the further node, the reward relating to the addition of a block to the blockchain.

Preferably, outputting a transmission comprises one or more of: adding a block to the blockchain; transmitting a message to one or more nodes of the blockchain; validating and/or signing a block of the blockchain; and transmitting a block of the blockchain to one or more nodes of the blockchain.

Preferably, the method comprises proposing a block for addition to the blockchain based on the parameter.

Preferably, the block comprises information relating to the parameter and/or the block comprises the parameter. Preferably, the block comprises information relating to the further node and/or the block determines the further node.

Preferably, determining the computational power devoted to the blockchain by the further node comprises one or more of: the identification of one or more proofs for a cryptographic problem, preferably wherein the proofs are valid for a predetermined period of time and/or a predetermined number of blocks; the determination of a difficulty of the proof(s); the identification of shares held by the further node relating to the solution of a cryptographic problem; the identification of a share verification contract (SVC); the determination of a hash rate of the further node; and the determination of the number of previous blocks proposed by the further node. The parameter is typically dependent on these determined factors.

Preferably, the computational power devoted relates to one or more of: an average devoted computational power, preferably a moving average; an average devoted computational power devoted over a plurality of blocks of the blockchain; an instantaneous computational power; a current computational power; and a historic computational power.

Preferably, the parameter is dependent on a deposit held by the further node in relation to the blockchain.

Preferably, the deposit relates to an amount of an asset relating to the blockchain.

Preferably, the method comprises determining one or more nodes that are eligible to participate in the addition of a block to the blockchain.

Preferably, eligibility is dependent on one or more of: holding a deposit in relation to the blockchain, preferably holding a deposit greater than a threshold deposit; and devoting a computational power to the blockchain, preferably devoting a computational power greater than a threshold computational power.

Preferably, a reward for the addition of a block to the blockchain is dependent on one or more of: the determined parameter; a deposit held by the further node in relation to the blockchain; a deposit held by other nodes in relation to the blockchain; the computational power devoted by the further node to the blockchain; and the computational power devoted by other nodes to the blockchain.

Preferably, the representations of the further node in a dynamic membership multi-signature are dependent on the computational power devoted by that further node.

Preferably, the parameter is dependent on two factors: the devoted computational power; and a deposit held by the further node in relation to the blockchain.

Preferably, the parameter is maximised when a value relating to the two factors is equal.

Preferably, the parameter is dependent on a minimum value of the two factors.

Preferably, the parameter is dependent on a linear function relating to the two factors.

Preferably, the parameter is dependent on the proportion of a factor held by the further node as compared to the proportion of this factor held by other nodes to the blockchain.

Certificates

According to another aspect of the present disclosure, there is described a computer-implemented method of outputting a transmission to a second node of a blockchain, the method being performed by a first node of the blockchain, the method comprising: identifying a certificate held by a further node of blockchain, wherein the certificate is associated with a contribution to a sybil-defence mechanism by one of the nodes of the blockchain; determining, based on the certificate, a parameter relating to: the influence of the further node on a consensus mechanism of the blockchain; and/or a reward for the further node; and outputting a transmission to the second node of the blockchain in dependence on the parameter.

According to least one aspect of the present disclosure, there is described a computer-implemented method of configuring a blockchain, such that a node of the blockchain is arranged to and/or required to: identify a certificate held by a further node of blockchain, wherein the certificate is associated with a contribution to a sybil-defence mechanism by one of the nodes of the blockchain; determine, based on the certificate, a parameter relating to: the influence of the further node on a consensus mechanism of the blockchain; and/or a reward for the further node; and output a transmission to the second node of the blockchain in dependence on the parameter.

According to least one aspect of the present disclosure, there is described a computer-implemented method of configuring a blockchain so that upon a block being proposed for addition to the blockchain and/or validated by a node, the node: identifies a certificate held by a further node of blockchain, wherein the certificate is associated with a contribution to a sybil-defence mechanism by one of the nodes of the blockchain; determines, based on the certificate, a parameter relating to: the influence of the further node on a consensus mechanism of the blockchain; and/or a reward for the further node; and outputs a transmission to the second node of the blockchain in dependence on the parameter.

According to least one aspect of the present disclosure, there is described a blockchain, wherein one or more of the blocks of the blockchain is dependent on a parameter relating to the influence of the node on a consensus mechanism of the blockchain and/or participation of a node in the addition of a block to the blockchain, wherein the parameter is dependent on a certificate held by the node.

According to least one aspect of the present disclosure, there is described an apparatus for recording entries on a blockchain, wherein the apparatus is arranged to: identify a certificate held by a node of blockchain, wherein the certificate is associated with a contribution to a sybil-defence mechanism by one of the nodes of the blockchain; determine, based on the certificate, a parameter relating to: the influence of the further node on a consensus mechanism of the blockchain; and/or a reward for the node; and outputting a transmission to a further node of the blockchain in dependence on the parameter.

Preferably, the certificate is associated with a contribution to the sybil-defence mechanism of a different node (e.g. a different node to the further node).

Preferably, the method comprises identifying a plurality of certificates held by the further node, wherein each certificate is associated with a different sybil-defence mechanism, and wherein the parameter is determined based on the plurality of certificates.

Preferably, each certificate is associated with a different type of sybil-defence mechanism.

Preferably, the certificate is associated with a contribution to on one or more of: a proof of work sybil-defence mechanism; a proof of stake sybil-defence mechanism; a proof of deposit sybil-defence mechanism; a proof of burn sybil-defence mechanism; and a proof of storage sybil-defence mechanism.

Preferably, each certificate is associated with a weighting.

Preferably, the weighting depends on the sybil-defence mechanism with which the certificate is associated.

Preferably, the weighting depends on the type of sybil-defence mechanism with which the certificate is associated.

Preferably, the parameter is dependent on a certificate held by the further node.

Preferably, the certificate is associated with the computational power devoted to the blockchain by a different node.

Preferably, the certificate is associated with a deposit held by a/the different node, the deposit relating to the blockchain.

Preferably, the certificate is transferable. Preferably, the certificate is transferrable to only certain other nodes of the blockchain.

Preferably, the certificate has a finite lifespan. Preferably, the certificate is valid for a finite number of blocks.

Preferably, the certificate is fungible.

Preferably, the certificate is limited, preferably geographically limited.

Multiple Blockchains

Preferably, the parameter is dependent on the activity of the further node on a further blockchain.

According to another aspect of the present disclosure, there is described a computer-implemented method of outputting a transmission to a second node of a blockchain, the method being performed by a first node of the blockchain, the method comprising: determining a measure of the activity of a further node of the blockchain on a further blockchain; determining based on the determined activity, a parameter relating to: the influence of the further node on a consensus mechanism of the blockchain; and/or a reward for the further node, the reward relating to the blockchain, preferably wherein the reward relates to the addition of blocks to the blockchain; and outputting a transmission to the second node of the blockchain in dependence on the parameter.

Preferably, the blockchain uses a proof of stake sybil-defence mechanism.

Preferably, the further blockchain uses a proof of work sybil-defence mechanism.

Preferably, the activity relates to the participation of the further node in the addition of blocks to the further blockchain. Preferably, the activity relates to a probability of the further node participating in the addition of a block to the further blockchain.

Preferably, the activity relates to a deposit held by the further node, the deposit relating to the further blockchain.

Preferably, a reward for participating in the addition of a block to the blockchain relates to the further blockchain. Preferably, the reward comprises an asset associated with the further blockchain.

Preferably, the parameter is maximised when the activity of the further node on the blockchain and on the further blockchain are equal.

Preferably, the parameter is dependent on a minimum activity on the blockchain and the further blockchain.

Preferably, the method further comprises recording on the blockchain an entry relating to a transaction that has occurred on the further blockchain.

Preferably, one or more transactions and/or blocks of the blockchain are recorded on the further blockchain. Preferably, the entirety of the blockchain is recorded on the further blockchain.

Preferably, the method further comprises determining the activity of the further node on a third blockchain.

Preferably, the parameter is based on a determined activity of the further node of the blockchain on the third blockchain

Preferably, the third blockchain is arranged so that: for a node of the third blockchain, there is determined a further parameter relating: to the influence of the third node on a consensus mechanism of the further blockchain; and/or to a reward for the third node, the reward relating to the further blockchain, preferably wherein the reward relates to the addition of blocks to the further blockchain; wherein the further parameter is based on the activity of the node of the third blockchain on the further blockchain.

Preferably, the parameter is dependent on a certificate held by the further node, wherein the certificate is associated with activity on the blockchain and/or the further blockchain of a different node.

Preferably, the certificate is transferable; and/or the certificate has a finite lifespan. Preferably wherein the certificate is valid for a finite number of blocks.

Preferably, the certificate relates to one or more of: the computational power devoted to the blockchain and/or the further blockchain by the different node; and a deposit relating to the blockchain and/or the further blockchain, the deposit being held by the different node.

According to an aspect of the present disclosure, there is described an apparatus arranged to store, access, and/or view the blockchain of any preceding claim. Preferably, the apparatus comprises a computer implemented device. Preferably, the apparatus comprises a display and/or a speaker. Preferably, the apparatus comprises a user input. Preferably, the apparatus is arranged to present information relating to the blockchain in dependence on a user request and/or an event.

Single Blockchain

According to least one aspect of the present disclosure, there is described a computer-implemented method comprising: determining a computational power devoted by a party to a blockchain; determining, based on the determined computational power, a parameter relating to the influence of the party on a consensus mechanism of the blockchain; and outputting a transmission to a node of the blockchain in dependence on the parameter.

Preferably, determining a parameter relating to the influence of the party comprises one or more of: determining a participation of the party in the addition of a block to the blockchain; and determining a degree of participation of the party in the addition of the block.

Preferably, the method is a method of outputting a transmission. Preferably, the method is a method of outputting a transmission to a node of a blockchain.

Preferably, the method is performed by a first node of the blockchain. Preferably the method comprises outputting a transmission to a second node of the blockchain in dependence on the parameter.

Preferably the party comprises a further node of the blockchain. Optionally, the party comprises the second node. Optionally, the party comprises a third node of the blockchain.

According to least one aspect of the present disclosure, there is described a computer-implemented method comprising: determining a computational power devoted by a party to a blockchain; determining, based on the determined computational power, a parameter relating to the participation of the party in the addition of a block to the blockchain; and outputting a transmission to a node of the blockchain in dependence on the parameter.

Preferably, the parameter relates to a reward for the party, the reward relating to the addition of the block to the blockchain and/or wherein determining a parameter comprises determining a reward for the party.

Preferably, the parameter relates to a probability of the party being a participant in the addition of the block.

Preferably, determining a parameter comprises determining a probability of the party being a participant in the addition of the block.

Preferably, the parameter relates to a degree of participation of the party in the addition of the block.

Preferably, determining a parameter comprises determining a degree of participation of the party in the addition of the block.

Preferably, the parameter relates to the eligibility of the further node to participate in a consensus mechanism of the blockchain.

Preferably, the parameter relates to the eligibility of the further node to participate in the addition of a block to the blockchain.

Preferably, the parameter is related to the addition of a block to the blockchain. Preferably, the block is proposed by a proposing node. Preferably, the proposing node is separate from and/or different to the further node.

Preferably, the method comprises designating the party as a participant in the addition of the block to the blockchain, preferably designating the party as a proposer and/or validator of the block.

Preferably, the block is a future block of the blockchain, preferably the next block of the blockchain.

Preferably, the blockchain uses a non-SoCP (signatures of computational power) consensus mechanism. Preferably, the blockchain uses a consensus mechanism based on signatures of knowledge.

Preferably, determining the computational power devoted by a party comprises determining a contribution of the party to a proof of work sybil-defence mechanism.

Preferably, outputting a transmission comprises: indicating the party as being a participant in the addition of the block to the blockchain; and/or indicating a reward for the party, the reward relating to the addition of the block to the blockchain.

Preferably, outputting a transmission comprises one or more of: adding a block to the blockchain in dependence on the parameter; transmitting a message to one or more nodes of the blockchain; validating and/or signing a block of the blockchain; and transmitting a block of the blockchain to one or more nodes of the blockchain.

According to least one aspect of the present disclosure, there is described a computer-implemented method of configuring a blockchain, such that a node of the blockchain is arranged to and/or required to: determine a computational power devoted by a party to a blockchain; determine a parameter relating to the influence of the party on a consensus mechanism of the blockchain and/or determine a parameter relating to the participation of the party in the addition of a block to the blockchain in dependence on the determined computational power; and output a transmission to a node of the blockchain in dependence on the parameter.

According to least one aspect of the present disclosure, there is described a computer-implemented method of configuring a blockchain so that upon a block being proposed for addition to the blockchain and/or validated by a node, the node: determines a computational power devoted by a party to a blockchain; determines a parameter relating to the influence of the party on a consensus mechanism of the blockchain and/or determines a parameter relating to the participation of the party in the addition of a block to the blockchain in dependence on the determined computational power; and outputs a transmission to a node of the blockchain in dependence on the parameter.

According to least one aspect of the present disclosure, there is described a blockchain, wherein one or more of the blocks of the blockchain is dependent on a parameter relating to the influence of the party on a consensus mechanism of the blockchain and/or participation of a party in the addition of a block to the blockchain, wherein the parameter relates to a computational power devoted by the party to the blockchain.

According to least one aspect of the present disclosure, there is described a blockchain comprising: a proof of work sybil-defence mechanism; and a non-SoCP (signatures of computational power) consensus mechanism, preferably a consensus mechanism based on signatures of knowledge.

Preferably, the proof of work sybil-defence mechanism is provided by a further blockchain.

Preferably, the blockchain is dependent on a further blockchain, the further blockchain comprising a proof of work sybil-defence mechanism.

According to least one aspect of the present disclosure, there is described an apparatus arranged to view, access, and/or store the aforesaid blockchain.

According to least one aspect of the present disclosure, there is described a computer-implemented method of pairing a proof of work sybil-defence mechanism with a non-SoCP (signatures of computational power) consensus mechanism. Preferably, the non-SoCP consensus mechanism comprises a consensus mechanism based on signatures of knowledge.

According to least one aspect of the present disclosure, there is described an apparatus for recording entries on a blockchain, wherein the apparatus is arranged to: determine a computational power devoted by a party to a blockchain; determine a parameter relating to the influence of the party on a consensus mechanism of the blockchain and/or determine a parameter relating to the participation of the party in the addition of a block to the blockchain in dependence on the determined computational power; and output a transmission to a node of the blockchain in dependence on the parameter.

According to least one aspect of the present disclosure, there is described a computer-implemented method of determining a computational power devoted by a party to a blockchain; and determining a parameter relating to the influence of the party on a consensus mechanism of the blockchain and/or determining a parameter relating to the participation of the party in the addition of a block to the blockchain in dependence on the determined computational power.

According to least one aspect of the present disclosure, there is described a computer-implemented method of determining a computational power devoted by a party to a public consensus network; determining a parameter relating to the influence of the party on a consensus mechanism of the blockchain and/or determining a parameter relating to the participation of the party in the addition of information to the public consensus network in dependence on the determined computational power; and outputting a transmission to a node of the public consensus network in dependence on the parameter.

Preferably, the method further comprises proposing a block for addition to the blockchain based on the parameter. Preferably, the block comprises information relating to the parameter and/or wherein the block comprises the parameter.

Preferably, the method further comprises proposing a block for addition to the blockchain based on the parameter. Preferably, the block comprises information relating to the party and/or wherein the block identifies the party.

Preferably, the method further comprises transmitting the parameter and/or a/the proposed block to one or more other nodes. Preferably, the method further comprises transmitting the parameter and/or a/the proposed block to one or more other nodes of the blockchain.

Preferably, the method further comprises outputting information relating to the parameter and/or outputting the parameter.

Preferably, the party is a node of the blockchain

Preferably, the method is a method implemented by a node of the blockchain. Preferably, the node and the party are each nodes of the blockchain. Preferably, the node and the party are different nodes of the blockchain.

Preferably, the parameter comprises a reward for the party for participating in the addition of the block to the blockchain.

Preferably, the reward comprises a reward for proposing and/or validating the block.

Preferably, the reward is included as one or more transactions in the block.

Preferably, the parameter comprises a probability of the party being designated as a participant in the addition of a block to the blockchain.

Preferably, determining the computational power devoted to the blockchain by the party comprises one or more of: the identification of one or more proofs for a cryptographic problem; the determination of a difficulty of the proof(s); the identification of shares held by the party relating to the solution of a cryptographic problem; the identification of a share verification contract (SVC); the determination of a hash rate of the party; and the determination of the number of previous blocks proposed by the party.

Preferably, the proofs are valid for a predetermined period of time and/or a predetermined number of blocks.

Preferably, the computational power devoted relates to one or more of: an average devoted computational power, preferably a moving average; an instantaneous computational power; a current computational power; and a historic computational power.

Preferably, the parameter is dependent on a deposit held by the party in relation to the blockchain. Preferably, the deposit relates to an amount of an asset relating to the blockchain.

Preferably, the method comprises determining one or more parties that are eligible to participate in the addition of the block.

Preferably, eligibility is dependent on the or each party holding a deposit in relation to the blockchain. Preferably, the determination comprises determining that the or each party holds a deposit greater than a threshold deposit; and

Preferably, eligibility is dependent on the or each party devoting a computational power to the blockchain.

Preferably, the determination comprises determining that the or each party is devoting and/or as devoted greater than a threshold computational power.

Preferably, the parameter is dependent on one or more of: the historical activity of the party; whether the party has been involved in the addition of any invalid and/or orphaned blocks; a transaction within the block and/or a previous block; and the involvement of the party in a transaction within the block and/or a previous block.

Preferably, a reward for the addition of a block to the blockchain is dependent on the parameter.

Preferably, a reward for the addition of a block is dependent on one or more of: a deposit held by the party in relation to the blockchain; a deposit held by other parties in relation to the blockchain; the computational power devoted by the party to the blockchain; and the computational power devoted by other parties to the blockchain.

Preferably, a reward for the addition of a block is awarded to both the proposer of the block and one or more validators of a block.

Preferably, a reward for the addition of a block is awarded to each party eligible to participate in the addition of the block.

Preferably, the representations of the party in a dynamic membership multi-signature are dependent on the computational power devoted by that party.

Preferably, the representations of the party in a dynamic membership multi-signature are dependent on one or more of: a deposit held by the party in relation to the blockchain; the computational power devoted by the party to the blockchain.

Preferably, the deposit comprises a deposit that has been held for a threshold amount of time, preferably held for at least 20 blocks, at least 50 blocks, and/or at least 100 blocks of the blockchain.

Preferably, the parameter is dependent on two factors: the devoted computational power; and a deposit held by the party in relation to the blockchain.

Preferably, the parameter is maximised when a value relating to the two factors is equal.

Preferably, the parameter is dependent on a minimum value of the two factors.

Preferably, the parameter is dependent on a linear function relating to the two factors.

Preferably, the parameter is dependent on the proportion of a factor held by the party as compared to the proportion of this factor held by other parties to the blockchain.

Preferably, the transmission comprises an indication that a threshold computational power relating to a block of the blockchain has not been exceeded and/or wherein the transmission comprises an indication that a threshold stake relating to a block of the blockchain has been exceeded.

Preferably, the transmission comprises an alarm if a threshold computational power relating to a block of the blockchain has not been exceeded.

Preferably, the method is implemented by a node of the blockchain.

Preferably, the party comprises a further node of the blockchain.

Multiple Blockchains

Preferably, the parameter is dependent on the activity of the party on a further blockchain. The activity may, for example, relate to the participation of the party in the addition of blocks to the further blockchain; a computational power devoted to the further blockchain by the party; and/or a deposit held by the party in relation to the further blockchain.

According to an aspect of the present invention, there is described a computer-implemented method comprising: determining a computational power devoted by a party to a blockchain; determining a parameter relating to the influence of the party on a consensus mechanism of the blockchain and/or determining a parameter relating to the activity of the party on a further blockchain; and outputting a transmission to a node of the blockchain and/or the further blockchain in dependence on the parameter.

According to an aspect of the present invention, there is described a computer-implemented method of configuring a blockchain, the method comprising configuring a blockchain so that upon a block being proposed for addition to the blockchain by a node, the node: determines a parameter relating to the influence of the party on a consensus mechanism of the blockchain and/or determines a parameter relating to a party proposing a block on the blockchain, wherein the parameter is dependent on the activity of the party on a further blockchain.

According to an aspect of the present invention, there is described a computer-implemented method of proposing a block for addition to a blockchain and/or validating a block of a blockchain, the method comprising: determining a parameter relating to the influence of the party on a consensus mechanism of the blockchain and/or determining a parameter relating to a party proposing a block on the blockchain, wherein the parameter is dependent on the activity of the party on a further blockchain.

According to an aspect of the present invention, there is described a blockchain, wherein one or more of the blocks of the blockchain comprises a parameter that relates to the influence of the party on a consensus mechanism of the blockchain and/or a parameter that relates to a party proposing a block on the blockchain, wherein the parameter is dependent on the activity of the party on a further blockchain.

According to an aspect of the present invention, there is described a blockchain comprising: a non-SoCP (signatures of computational power) consensus mechanism; wherein the blockchain is dependent on a further blockchain, the further blockchain comprising a proof of work sybil-defence mechanism.

Preferably, the non-SoCP consensus mechanism comprises a consensus mechanism based on signatures of knowledge.

According to an aspect of the present invention, there is described an apparatus for recording entries on a blockchain, wherein the apparatus is arranged to: determine a parameter relating to the influence of the party on a consensus mechanism of the blockchain and/or determine a parameter relating to a party proposing a block on the blockchain, wherein the parameter is dependent on the activity of the party on a further blockchain.

According to an aspect of the present invention, there is described a computer-implemented method of determining a parameter relating to the influence of the party on a consensus mechanism of the blockchain and/or determining a parameter relating to the addition of a block to a blockchain by a party, wherein the parameter is dependent on the activity of the party on a further blockchain.

According to an aspect of the present invention, there is described a computer-implemented method of configuring a public consensus network, the method comprising configuring a public consensus network so that upon information being proposed for addition to the public consensus network by a node, there are carried out the steps: determining a parameter relating to the influence of the party on a consensus network of the blockchain and/or determining a parameter relating to a party proposing information on the public consensus network, wherein the parameter is dependent on the activity of the party on a further public consensus network.

Preferably, the method further comprises proposing a block for addition to the blockchain based on the parameter. Preferably, the block comprises information relating to the parameter and/or wherein the block comprises the parameter.

Preferably, the method further comprises transmitting the parameter and/or a/the proposed block to one or more other nodes. Preferably, the method further comprises transmitting the parameter and/or a/the proposed block one or more other nodes of the blockchain and/or the further blockchain.

Preferably, the method further comprises outputting information relating to the parameter and/or outputting the parameter.

Preferably, the method further comprises recording on the blockchain an entry comprising a reward for participating in the addition of the block on the blockchain. Preferably, the reward is dependent on the parameter.

Preferably, the blockchain uses a proof of stake sybil-defence mechanism and/or the further blockchain uses a proof of work sybil-defence mechanism.

Preferably, the further blockchain uses a consensus mechanism based on signatures of computational power (SoCP).

Preferably, the parameter relates to a probability of the party participating in the addition of a block on the further blockchain.

Preferably, the parameter relates to a deposit held by the party, the deposit relating to the further blockchain.

Preferably, the parameter relates to one or more of: a computational power devoted by the party to the further blockchain; a hash rate of the party on the further blockchain; and a deposit relating to the further blockchain held by the party.

Preferably, a reward for participating in the addition of the block to the blockchain relates to the further blockchain. Preferably, the reward comprises an asset (e.g. a coin) associated with the further blockchain.

Preferably, the parameter is dependent on the ratio of the devoted computational power (and/or network hash rate) of the party in relation to the further blockchain to the total devoted computational power (and/or total network hash rate) for the further blockchain.

Preferably, the parameter is dependent on a deposit held by the miner in relation to the further blockchain.

Preferably, the parameter is dependent on the ratio of the deposit held by the party in relation to the further blockchain to the total deposit held by all parties of the further blockchain.

Preferably, the parameter is dependent on a deposit relating to the party.

Preferably, the deposit is arranged to not be removable for a certain number of blocks and/or a certain period of time.

Preferably, the deposit is arranged to be required to have been made a certain number of blocks ago and/or a certain amount of time before the participation of the party in the addition of the block.

Preferably, the parameter is dependent on the activity of the miner on the blockchain.

Preferably, the parameter is maximised when the activity of the party on the blockchain and on the further blockchain are equal.

Preferably, the parameter is dependent on a minimum activity on the blockchain and the further blockchain.

Preferably, the activity relates to one or more of: a computational power devoted by the party to the blockchain and/or the further blockchain; and a deposit held by the party in relation to the blockchain and/or the further blockchain.

Preferably, the activity relates to a ratio of an activity to the activity of all parties on the blockchain and/or the further blockchain.

Preferably, the method recording on the further blockchain an entry relating to a transaction that has occurred on the blockchain.

Preferably, the further blockchain is arranged to automatically record one or more of the transactions recorded on the blockchain.

Preferably, the method further comprises recording on the blockchain an entry relating to a transaction that has occurred on the further blockchain.

Preferably, the blockchain and the further blockchain are associated with each other. Preferably, the security of the blockchain is dependent on the further blockchain.

Preferably, one or more transactions and/or blocks of the blockchain are recorded on the further blockchain.

Preferably, the entirety of the blockchain is recorded on the further blockchain.

Preferably, the parameter is dependent on the activity of the party on a plurality of blockchains.

Preferably, a parameter associated with a first blockchain is dependent on the activity on a second blockchain, and a parameter associated with the second blockchain is dependent on the activity on a third blockchain.

Preferably, the parameter is dependent on a certificate held by the party, wherein the certificate is associated with activity on the blockchain and/or the further blockchain of a further party.

Preferably, the certificate is tradeable and/or transferable between the party and a further party.

Preferably, the certificate has a finite lifespan. Preferably, the certificate is valid for a finite number of blocks.

Preferably, the method further comprises evaluating a certificate held by the party, wherein the parameter is dependent on the certificate.

Preferably, the certificate relates to the computational power devoted to the blockchain by the party.

Preferably, the certificate relates to the computational power devoted to the blockchain by a/the further party.

Preferably, the certificate relates to the computational power devoted to the further blockchain by the party.

Preferably, the certificate relates to the computational power devoted to the further blockchain by a/the further party.

Preferably, the certificate relates to a deposit relating to the blockchain, the deposit being held by the party.

Preferably, the certificate relates to a deposit relating to the blockchain, the deposit being held by a/the further party.

Preferably, the certificate relates to a deposit relating to the further blockchain, the deposit being held by the party.

Preferably, the certificate relates to a deposit relating to the further blockchain, the deposit being held by a/the further party.

Preferably, the method further comprises outputting the block and/or a transaction of the block.

According to another aspect of the present disclosure, there is described an apparatus arranged to carry out the aforesaid method.

According to another aspect of the present disclosure, there is described an apparatus arranged to store, access, and/or view the aforesaid blockchain and/or the aforesaid public consensus network.

Preferably, the apparatus comprises a computer implemented device.

Preferably, the apparatus comprises means for presenting information. Preferably, the apparatus comprises a display and/or a speaker.

Preferably, the apparatus comprises a user input.

Preferably, the apparatus is arranged to present information relating to a/the blockchain and/or a/the public consensus network in dependence on a user request and/or an event.

Preferably, the apparatus is arranged to communicate with at least one other apparatus.

Preferably, the apparatus comprises a node of the first blockchain and/or the second blockchain and/or the first public consensus network and/or the second public consensus network. Preferably, the apparatus is arranged to communicate with another node of the first and/or second blockchain and/or the first and/or second public consensus network.

According to another aspect of the present disclosure, there is described a system comprising a plurality of apparatuses arranged to store, access, and/or view the aforesaid blockchain and/or the aforesaid public consensus network.

Preferably, each of the apparatuses are arranged to communicate with each other.

Preferably, each of the apparatuses are arranged to communicate so as to propagate blocks of the blockchain to the other apparatuses.

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

While proof of stake systems typically do not comprise miners in the same way as proof of work systems, for the sake of this description (and for the sake of describing methods that are applicable to both proof of work and proof of stake systems) the party proposing a block in a proof of stake system is considered to be a miner. More generally, as used herein the term mining refers to the general process of proposing a block for addition to a blockchain, or proposing information for addition to a public consensus network, as well as the specific process used for proof of work systems.

Similarly, the term proposing is used to describe the proposal of blocks to both a proof of work system and a proof of stake system, where proposing may be synonymous with mining in certain contexts.

More generally, the term participating is used in the below description. The participants in the addition of a block typically include: miners, proposers, validators, and signers of blocks.

Embodiments of the disclosure are described below, by way of example only, with reference to the accompanying drawings.

### BRIEF DESCRIPTION OF THE DRAWINGS

FIG. 1 shows a blockchain on which the methods disclosed herein can be implemented.

FIG. 2 illustrates a computer device on which aspects of the disclosed system are implemented.

FIG. 3 shows a network on which aspects of the disclosed system are implemented.

FIG. 4 shows a flowchart for a method of determining a parameter relating to the influence of a party on the consensus mechanism.

FIG. 5 shows a flowchart for another method of determining a parameter relating to the influence of a party on the consensus mechanism.

FIG. 6 shows a system comprising a main chain and a side chain.

FIG. 7 shows two exemplary parties that contribute to the addition of blocks on the main chain and the side chain.

FIG. 8 shows a method of determining a parameter relating to the addition of a block on the side chain.

FIGS. 9a and 9b show systems comprising a main chain, a side chain, and a third chain.

FIG. 10 shows a flowchart for a method of rewarding a party for proposing a block.

### DETAILED DESCRIPTION OF THE EMBODIMENTS

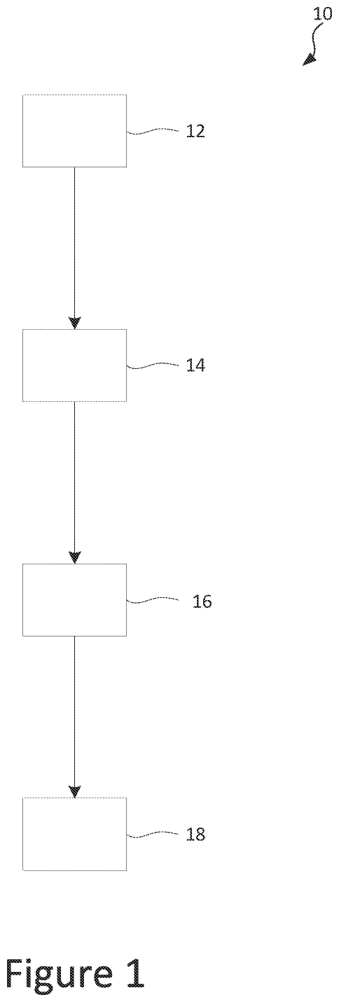

Referring to FIG. 1, there is shown a blockchain 10. The blockchain comprises a first block 12, a second block 14, a third block 16, and a fourth block 18. Each block is dependent on the previous block, so that the fourth block depends on the third block, the third block depends on the second block, and the second block depends on the first block. More generally, the nth block of the blockchain depends on the (n−1)th block and thereby depends on each previous block of the blockchain.

In this way, the blockchain 10 is useable to implement an immutable ledger. Any change to a block of the blockchain alters each subsequent block and so is immediately detectable.

Typically, each block comprises a hash of the previous block; changing any block of the blockchain 100 will alter the hash of that block and therefore alter the hash of each subsequent block (since the subsequent hashes depend on the altered hash).

Typically, each block comprises a body, which contains a record of transactions within the block, and a header, which comprises information relating to the block. For example, the header may comprise: a value relating to these transactions (e.g. a hash relating to a Merkle tree, which Merkle tree comprises the transactions); a value (e.g. a hash) relating to a previous block and/or a value relating to a proof of work puzzle that has been solved in order to mine the block.

Typically, the blockchain comprises a decentralized blockchain and/or a distributed blockchain. More generally, the methods described herein are applicable to distributed ledgers and/or public consensus networks (PCNs), e.g. networks that require a consensus between a plurality of participant nodes.

Typically, each block comprises information regarding a change of state of a variable. In an unspent transaction output (UTXO) blockchain, such as Bitcoin, the block may comprise a series of transactions between two addresses (e.g. between a sender and a recipient). Typically, in UTXO blockchains, the addresses are single use, so that each address is used only a single time as the sender for a transaction. In an account model blockchain, such as Ethereum, the block may comprise a series of state changes for an account (e.g. an account may receive an amount of currency and/or a state of the account may change). The accounts typically persist throughout the blockchain, such that accounts can be referenced repeatedly.

Each block of the blockchain 10 typically comprises at least one a dynamic-membership multi-party signature (DMMS) which is the basis for a consensus mechanism; the DMMS may comprise signatures of computational power (SoCP) and/or signatures of knowledge (SoK).

The blockchain 10 typically uses a sybil-defence mechanism, such as a proof of work and/or proof of stake sybil-defence mechanism.

A consensus mechanism based on signatures of computational power employs evidence of computational power in order to build consensus on a history. Therefore, only parties that have committed a certain computational power to the blockchain 10 may be eligible to contribute to building a consensus on a history of the blockchain. In particular, only parties that have committed a certain computational power may be able to signal a favoured choice of history.

Using Bitcoin as an example, a candidate history is selected by selecting an existing fork of the blockchain; typically this involves selecting the longest fork of the blockchain. A new block can then be added to this selected fork of the blockchain by a party that holds a relevant signature of computational power.

Typically, consensus mechanisms based on signatures of computational power are paired with proof of work sybil-defence mechanisms. As an example, Bitcoin uses a proof of work sybil-defence mechanism, and the signatures of computational power are related to the proof of work sybil-defence mechanism. More specifically, when a party finds a suitable nonce for the cryptographic problem of Bitcoin, a signature of computational power for this party is included in the DMMS for the block and this party becomes eligible to signal a favoured choice of history (e.g. to decide on a fork of Bitcoin to which the block should be added).

Other examples of networks that use a consensus mechanism based on signatures of computational power include Ethereum and GraphChain (which is based on a Directed Acyclic Graph as opposed to a blockchain).

A consensus mechanism based on signatures of knowledge employs evidence of knowledge in order to build consensus on a history. Therefore, only parties that hold relevant knowledge may be eligible to contribute to building a consensus on a history of the blockchain 10. The knowledge may, for example, relate to knowledge of private keys that relate to (public keys relating to) an amount of a cryptographic asset.

Typically, a consensus mechanism based on signatures of knowledge is paired with a proof of stake sybil-defence mechanism. In particular, the extent of participation of each party holding signatures of knowledge may depend on a deposit held by that party, where those parties with higher deposits are eligible to participate to a greater extent in the addition of blocks.

As mentioned above, conventionally a consensus mechanism based on signatures of computational power is paired with a proof of work sybil-defence mechanism. With Bitcoin, in order to propose a block for addition to the blockchain, the miner presents a solution to a cryptographic puzzle. This solution is evidence of computational power expended by the miner and so contributes to the signatures in the DMMS as well as providing proof of work for the sybil-defence mechanism.

Equally, conventionally a consensus mechanism based on signatures of knowledge is paired with a proof of stake sybil-defence mechanism. A signature may evidence ownership of a certain blockchain address, which blockchain address relates to a certain amount of an asset relating to the blockchain.

The present disclosure relates, in part, to a blockchain that pairs a proof of work sybil-defence mechanism with a non SoCP consensus mechanism (e.g. a consensus mechanism based on signatures of knowledge).

This arrangement can enable the provision of a blockchain with a fast time to finality (e.g. a blockchain on which transactions can be rapidly confirmed), while benefiting from the non-centralising properties of the proof of work sybil-defence mechanism. More generally, the present disclosure describes methods of pairing of a proof of work sybil-defence mechanism with any consensus mechanism (including an SoCP consensus mechanism).

While this description primarily refers to consensus mechanisms based on signatures of computational power and signatures of knowledge, it will be appreciated that consensus mechanisms may be based on other factors. For example, a consensus mechanism based on a verifiable delay puzzle (e.g. ‘signatures of computation time (SoCT)’) is described in “Long and Wei Nakamoto Consensus with Verifiable Delay Puzzle; 2019; https://arxiv.org/pdl/1908.06394.pdf”. The disclosures herein largely relate to the pairing of a proof of work sybil-defence mechanism with any consensus mechanism. In some embodiments, the consensus mechanism is a consensus mechanism that is not based on signatures of computational power (e.g., a non-SoCP consensus mechanism).

More generally, the present disclosure relates to a method of determining a parameter of the participation of a party for a block of the blockchain 10 based on a determined computing power related to said party.

Furthermore, the present disclosure relates to a method of rewarding a party following the addition of a block to the blockchain 10 based on a determined computing power and/or a deposit related to said party.

While the entries on the blockchain may comprise transactions relating to an asset (e.g. an amount of Bitcoin), it will be appreciated that blockchains may be used for numerous other purposes. In addition to, or instead of, transactional data, entries may comprise regulatory data, records of transfers of goods, indications of user activity, etc. In general, blockchains are useful for storing entries relating to any situation where an immutable ledger is desirable.

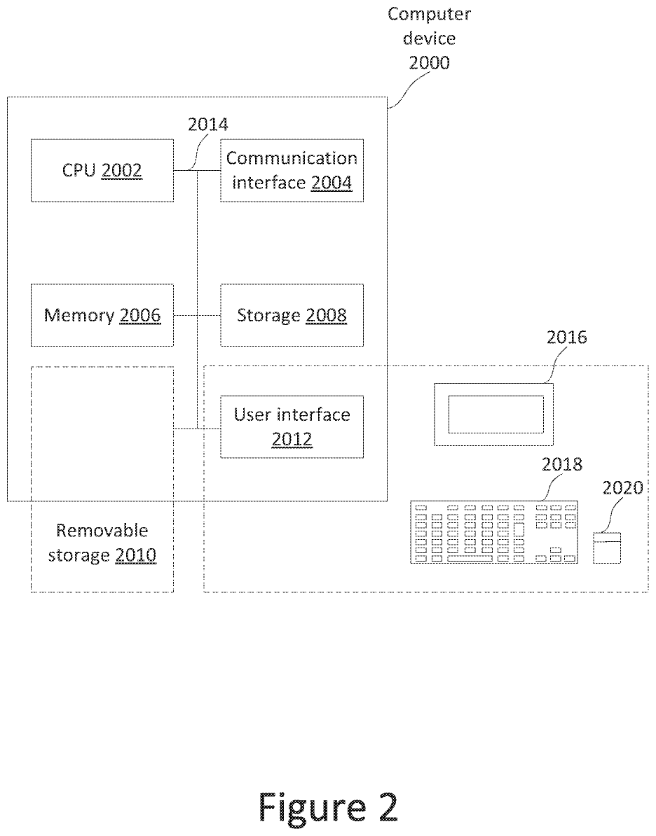

Referring to FIG. 2, the blockchain 10, is configured, added to, and/or viewed using a computer device 2000. In particular, each node that validates transactions is implemented using the computer device 2000. Similarly, each mining or proposing node, which propose blocks for addition to the blockchain, is implemented using the computer device 2000. Furthermore, each viewer of the blockchain accesses the blockchain using the computer device 2000. Nodes, miners, and/or viewers may be implemented on the same computer device.

Each computer device 2000 typically comprises a processor in the form of a CPU 2002, a communication interface 2004, a memory 2006, storage 2008, removable storage 2010 and a user interface 2012 coupled to one another by a bus 2014. The user interface comprises a display 2016 and an input/output device, which in this embodiment is a keyboard 2018 and a mouse 2020.

The CPU 2002 executes instructions, including instructions stored in the memory 2006, the storage 2008, and/or the removable storage 2010.

The communication interface 2004 is typically an Ethernet network adaptor coupling the bus 2014 to an Ethernet socket. The Ethernet socket is coupled to a network, such as the Internet. The communication interface facilitates communication between the nodes of the blockchains and enables each node to validate and propagate transactions and each miner to propose blocks to the network. It will be appreciated that any other communication medium may be used by the communication interface, such as area networks, infrared communication, and Bluetooth®.

The memory 2006 stores instructions and other information for use by the CPU 2002. The memory is the main memory of the computer device 2000. It usually comprises both Random Access Memory (RAM) and Read Only Memory (ROM).

The storage 2008 provides mass storage for the computer device 2000. In different implementations, the storage is an integral storage device in the form of a hard disk device, a flash memory or some other similar solid state memory device, or an array of such devices. To run a full node of the blockchain 10, that is a node which contains the entirety of the blockchain, the storage is typically required to have a large capacity. The computer device may also be capable of running a partial, or light, node, where the storage 2008 stores only a portion of the blockchain.

The removable storage 2010 provides auxiliary storage for the computer device 2000. In different implementations, the removable storage is a storage medium for a removable storage device, such as an optical disk, for example a Digital Versatile Disk (DVD), a portable flash drive or some other similar portable solid state memory device, or an array of such devices. In other embodiments, the removable storage is remote from the computer device, and comprises a network storage device or a cloud-based storage device.

Each node, miner, and viewer uses a computer device 2000 to implement aspects of the methods and systems as described herein. Typically, the computer device used by each party is specialised; for example miners proposing blocks to be added to a blockchain may use a computer device that comprises an application specific integrated circuit (ASIC), a field programmable gate array (FPGA), or a graphics processing unit (GPU). In some embodiments, the computer device comprises numerous racks of ASICs, FPGAs, or GPUs with a single user interface, where the computer device may be wholly specialised for mining blockchains.

Typically, the computer device 2000 of each node is arranged to receive transactions, to validate these transactions, and then to propagate the validated transactions throughout a network. The computer devices of the miners (which miners may also be nodes) are then able to collate a number of validated transactions into a block; this block can then be proposed for addition to a blockchain. The addition of the proposed block to the blockchain 10 may rely on, for example, providing a proof-of-work (as occurs in e.g. Bitcoin: “Bitcoin: A Peer-to-Peer Electronic Cash System. Nakamoto, S. (2008) https://bitcoin.org/bitcoin.pdf”) or providing a proof-of-stake (as occurs in e.g. Algorand: “ALOG RAND Chen, J. (2017) https://arsiv.org/pdf/1607_01341.pdf).

In an exemplary usage of the blockchain 10, a node combines a number of transactions into a block, and then proposes this block for addition to the blockchain. Other nodes validate and propagate this block to the users of the blockchain. Once the block is added to the blockchain, a transaction included in this block can be presented to a user, where the information contained in the transaction can be used for a variety of purposes (e.g. to improve the design of machines, to ensure adherence to government regulations, or to identify risky or endangering behaviour). It will be appreciated that while the term transaction is used throughout—and is commonly used in reference to blockchains—each blockchain is more generally capable of the (preferably immutable) storage of information. Therefore, while transactions may relate to a transfer of currency, more generally the transactions in a block may relate to any information and may have no relation to financial transactions.

A computer program product is provided that includes instructions for carrying out aspects of the method(s) described below. The computer program product is stored, at different stages, in any one of the memory 2006, storage device 2008 and removable storage 2010. The storage of the computer program product is non-transitory, except when instructions included in the computer program product are being executed by the CPU 2002, in which case the instructions are sometimes stored temporarily in the CPU or memory. It should also be noted that the removable storage is removable from the computer device 2000, such that the computer program product may be held separately from the computer device from time to time. Different computer program products, or different aspects of a single overall computer program product, are present on the computer devices used by any given miner and/or user of a blockchain.

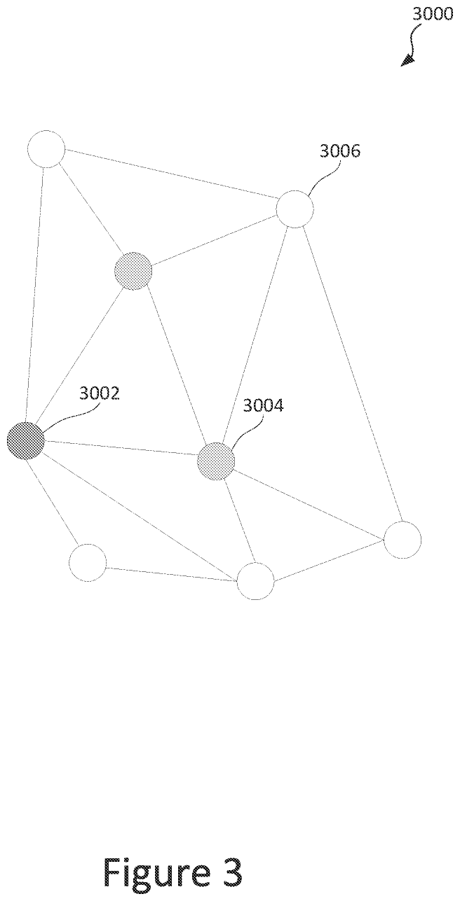

Referring to FIG. 3, the methods disclosed herein are typically implemented in relation to a network 3000, which network is typically arranged to view, add to, and/or configure a blockchain (e.g. the blockchain 10 of FIG. 1).

The network 3000 comprises one or more nodes 3002, 3004, 3006, which nodes are arranged to communicate (directly or indirectly) to propagate information. The nodes typically comprise computer devices.

The network 3000 may have one or more of the following properties:
Be a centralized network, in which communications are propagated by a single node (or a group of nodes).
Be a decentralised network, in which nodes of the network are arranged to communicate with each other directly (e.g. not via a central authority).
Be a distributed network, where records relating to the network are stored on a plurality of the nodes. This prevents a single node from editing the record (since this editing would be noticed by the other nodes).

Typically, the disclosures herein are implemented on a decentralised, and/or distributed, network.

The nodes 3002, 3004, 3006 are arranged to communicate with each other so as to propagate information throughout the network. This information typically comprises blocks of the blockchain. The nodes may be configured differently and/or arranged to provide different services. For example, the network may comprise:
A mining node 3002, which mining node is arranged to propose blocks for addition to the blockchain.
A validating node 3004, which validating node is arranged to validate the blocks proposed by the miner (e.g. confirm that the blocks are correctly formatted and/or comprise valid transactions). A validating node may run a ‘full’ node and comprise a record of the entire blockchain. Such a full validating node may validate a block of the blockchain based on previous blocks of the blockchain (e.g. to ensure that a party transferring an asset does indeed hold that asset). A validating node may run a ‘light’ or ‘partial’ node and comprise a record of only a part of the blockchain. Such a partial validating node may validate a block based on the transactions in that block and/or block headers from previous blocks (e.g. to ensure that a hash of the transactions of block corresponds to a value in the header of the block).
A propagating node 3006, which propagating node is arranged to receive information from other nodes and then forward this information to ensure that it reaches other nodes in the network.

More generally, one or more nodes of the network may be arranged to influence a consensus mechanism of the blockchain, to participate in the addition of blocks to the blockchain and/or to propagate blocks throughout the network.

It will be appreciated that nodes may provide a plurality of services; for example, mining nodes typically also perform validation and propagation.

The methods disclosed herein are typically carried out by one or more of the nodes of the network 3000, so that where the description refers to a ‘party’, this party is typically one or more of: a node of the network; a group of nodes of the network; and a user that controls one or more nodes of the network.

Typically, nodes and/or parties are implemented on the computer device 2000. The methods described herein may then be performed using the computer device. The methods typically relate to an interaction between computer devices, where information may be transmitted between the computer devices of a plurality of nodes. In particular, information determined at a first computer device (e.g. a first node) may be transmitted to a second computer device (e.g. a second node) and output on the further computer device. Where the information is part of a block of the blockchain, the second computer device may be able to determine that the information is recorded in an immutable manner. The information, and the knowledge that it is recorded in an immutable manner, can affect the actions of the second node and/or the party controlling the second node.

Single Blockchain

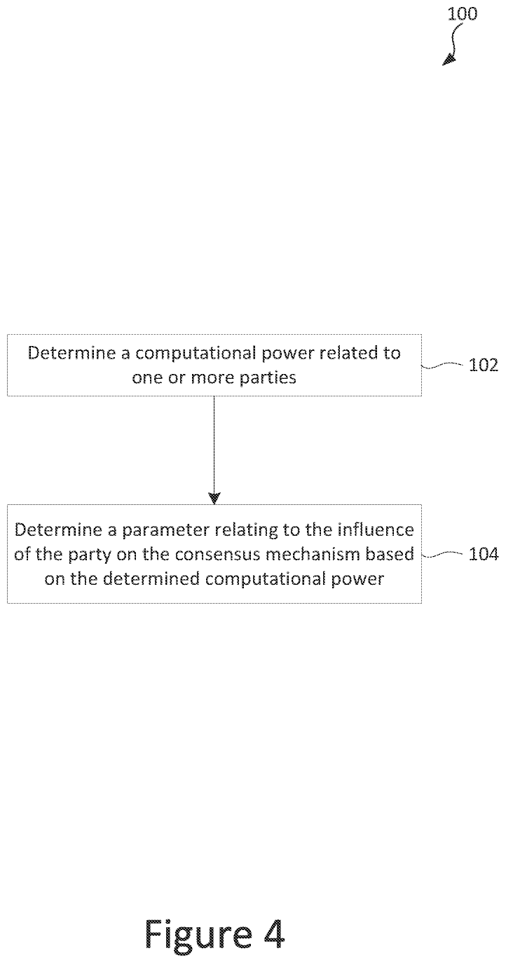

Referring to FIG. 4, there is described a method 100 of determining a parameter relating to the influence of a party on the consensus mechanism based on a computational power related to one or more parties. The parameter may, for example, relate to a probability of the party participating in the addition of a block to the blockchain. The method may be carried out by (the computer device 2000 of) a node of the blockchain and/or the blockchain may be configured such that the method is carried out automatically. In some embodiments, the method is carried out by a participant of a previous block. For example, to determine a participant for the (n+1)th block, this method may be carried out by a participant of the nth block (e.g. a validator of the nth block). In particular, the method may be carried out by a participant of the nth block, where a participant of the (n+1)th block is determined by this participant of the nth block and/or is dependent on an action of the participant of the nth block. Typically, the method is required by the consensus rules of the blockchain, such that the blockchain is configured to require a node to carry out the method.

In a first step 102, a computational power relating to one or more parties is determined. Typically, this comprises a node determining a proportion of computational power that is devoted to the blockchain by parties participating in the addition of blocks to the blockchain 10. In various embodiments, the determination of the computational power comprises one or more of:
Analysing signatures of computational power (e.g. in the DMMS of a block of the blockchain).
Determining a present computational power devoted to the blockchain.
Determining a historic computational power devoted to the blockchain.
Determining an average historical computational power devoted to the blockchain (e.g. over the previous 24 hours, the previous week, the previous fortnight, and/or the previous month).

In a second step 104, a parameter relating to the influence of the party on the consensus mechanism of the blockchain is determined. Typically, this comprises the determination of block participant (e.g. a proposer, a validator, and/or a participant in the consensus mechanism of the blockchain 10) is based on the determined computational power. This second step may comprise determining such a parameter for a plurality of parties (e.g. the second step may comprise determining a plurality of parties to be participants in the addition of a block, such as determining a plurality of validators and/or determining a proposer and one or more validators). A degree of participation (e.g. whether a party is selected as a proposer or as a validator) for one or more parties may also depend on the determined computational power(s). Typically, the determined computational power comprises an amount of computational power that is devoted to and/or committed to the blockchain by a party. This may, for example, be an amount of computational power that is being used by this party to solve a cryptographic problem.

In some embodiments, the blockchain 10 uses a signatures of knowledge consensus mechanism, where the number of signatures that any party is eligible to contribute is dependent on, and/or proportional to, the devoted computational power.

Typically, where the consensus mechanism of the blockchain 10 is based on signatures of knowledge, the selection of the participant is random and/or pseudorandom. In particular, the probability of a party being selected as a participant is typically dependent on a deposit held by that party, where the participants are selected randomly based on this probability.

More generally, the signatures contributed by a party (for any consensus mechanism) may be weighted using the parameter determined based on the devoted computed power. For example, where a signatures of computational proof consensus method is used (e.g. in Bitcoin), a number of parties may be able to select a fork of the blockchain on which to build, where a number of votes for each party is based on the parameter determined for each party.

With the present disclosure, the influence a party has on the consensus mechanism (e.g. a possibility of being selected as a participant in the addition of a block) is based on the determined computational power. For a given block, there typically remains a random element. In particular, the probability of a party on the blockchain being selected as a participant is typically proportional to the computer power determined in relation to that party.

Therefore, in some embodiments, if a party is responsible for 5% of the total computing power devoted to the blockchain 10, this party has a 5% chance of being selected as a participant in the addition of a block (e.g. as a participant in a round of the consensus mechanism). Typically, the degree of participation depends on the devoted computational power. In some embodiments, the probability of participation depends on the devoted computational power, whereas the degree of participation (e.g. whether a party is selected as a proposer or as a validator) depends on other factors (e.g. the determination of degree may be random).

The selection of a participant may also depend on:
Historic activity of that party. In particular, parties may only be allowed to propose a certain proportion of blocks and/or a certain number of blocks in a given time. A party that has proposed the nth block may be subject to a waiting period such that this party is prohibited from proposing the (n+1)th block.
The probability of a party being selected as a participant may also increase as the time since their last participation increases.
In some embodiments, parties that are found to have acted undesirably (e.g. parties that have taken part in an attack on the blockchain) are prohibited from participating in the addition of blocks.
A transaction within a block. For example, a party that has recently been involved in a large transaction may be prohibited from taking part in the proposal and/or validation of a number of following blocks.

Typically, the proposer of a block receives a reward for proposing said block. In particular, the proposer may receive a proposing award (e.g. a block reward) and/or a reward relating to transactions in the block (e.g. transaction fees). Parties may offer transaction fees in order to incentivise the proposer to include those transactions in a block. These fees, and any proposing award, are typically received in full by the proposer; however, a portion (or all) of the fees may also be received by other participants (e.g. the validators of the block and/or one or more eligible participants). Eligible participants are typically those parties that have devoted an amount of computational power to the blockchain 10 (and there may be a threshold devotion of computational power required to become eligible).

In some embodiments, the rewards are split between eligible participants based on a parameter for each of the participants. This provides certainty of rewards regardless of whether an eligible participant actually participates in the addition of a block to the blockchain.

In some embodiments, eligible participants are able to choose whether to participate in the addition of blocks to the blockchain and/or the building of a consensus. In particular, parties may choose to devote computational power to the blockchain without offering to participate in the addition of blocks. Such parties may still be considered to be eligible participants (by dint of their devoting computational power to the blockchain) and such parties may still receive rewards relating to the addition of blocks to the blockchain.

By basing a party's eligibility to participate on a computing power devoted to the blockchain by that party, the advantages of a proof of work sybil-defence mechanisms may be combined with any consensus mechanism. This can enable a blockchain to use a consensus mechanism with which proposers and validators of a block are selected rapidly, while benefiting from the de-centralisation forces conferred by a proof of work sybil-defence mechanism.

The computational power devoted by a party is typically determined based on the submission of proofs to cryptographic problems (e.g. cryptographic puzzles). This can be explained with reference to Bitcoin. As described above, in Bitcoin parties seek to find a nonce that is a solution to a particular cryptographic problem. The determination of this nonce comprises proof that a miner has done a certain amount of work and based on this the miner is able to propose a block for addition to the blockchain.

A similar method can be used to determine the computational power devoted by parties to the blockchain 10. In particular, parties may be able to submit proofs to the blockchain 10, which proofs comprise a solution to a cryptographic problem related to the blockchain. These proofs thus comprise evidence that the parties have devoted computing power to the blockchain. It will be appreciated that there are a number of other ways of demonstrating an amount of computer power that is devoted to the blockchain (for example, a submission of device usage). This use of proofs to demonstrate computational power may be considered to involve the determination of computational power based on proven computational power (where the submission of solutions comprises proof of the devotion of computational power).

An exemplary method for verifying proofs uses share verification contracts (SVCs). As an example, a share verification contract may comprise a smart contract which can verify the validity of a bunch of (commits to) hash shares submitted to the contract (verification may be probabilistic). Here, the requirement is that it should not be possible, on average, to profit from submission of invalid shares. In this context, validity of a hash share requires that:
The hash share corresponds to a current or recent block header;
The hash shares meets a target difficulty;
The hash share is not a duplicate of a previously submitted share.

SVCs are explained in more detail in “Loi Luu, Yaron Velner, Jason Teutsch, and Prateek Saxena. Smartpool: Practical decentralized pooled mining. In 26^{th} {USENIX} Security Symposium ({USENIX} Security 17), pages 1409-1426, 2017”.

Proofs (e.g. proofs verified by SVCs) may be included on the blockchain 10, e.g. included in a transaction in a block of the blockchain. Typically, proofs are included in a block of the blockchain and then considered for subsequent blocks (e.g. the owner of a proof is then eligible to participate in the addition of a certain number of subsequent blocks).

In some embodiments, proofs are provided separately to the blockchain. For example, nodes may be arranged to transmit proofs directly to other nodes.

In some embodiments, proofs may be transferred between parties. As an example, a first party may be able to find a proof and then transfer this proof to a second party, which second party is able to submit the proof to nodes of the blockchain so as to become eligible for participation in the addition of a block. This enables a party to become rapidly involved in the addition of blocks to the blockchain 10 (by receiving proofs from a different party that has previously devoted computational power to the blockchain).

The representations of parties in a DMMS of a block of the blockchain 10 may be based on the computational power devoted by that party. Using the example of a consensus mechanism based on signatures of knowledge, signatures of knowledge may be awarded to parties based on their devoted computational power and/or proofs submitted by said parties. These signatures of knowledge may then be considered during the selection of a participant in the addition of a subsequent block. Equally, the proofs may themselves comprise signatures of knowledge, where participants are determined based on the submission and/or holding of proofs.

The representations of parties in the DMMS may also, or alternatively, be based on a deposit relating to that party (deposits are described further below).

Typically, the representation of a party in the DMMS is one or more of:
Dependent on a devoted computational power relating to the party.
Proportional to a devoted computational power relating to the party.
Dependent on a deposit relating to the party.
Proportional to a deposit relating to the party.

Typically, the determination of the computational power devoted by each party comprises the determination of a moving average of the number of proofs submitted by each party. The use of a moving average has a number of benefits: it prevents new entrants from rapidly gaining a large share of the computational power, it does not penalize parties who are having a short unfortunate streak (e.g. in some cases a party will not find a proof for a while despite devoting a significant computational power); and it rewards long term commitment to the blockchain.

While the number of proofs is considered above, more specifically the determination may be based on: a number of proofs and/or a difficulty of proofs. Parties may be able to solve problems of different difficulties, where the reward for solving these problems (e.g. the effect on the probability of the party being a participant in a subsequent block) depends on the difficulty of the problem. This enables parties of different size to be involved in the addition of blocks to the blockchain, where large parties (those with a lot of computational power) may attempt to solve more difficult problems. The determination of the computational power may then depend on a determination of hash shares held by each party, where the hash shares may relate to proofs of different difficulties.

Bitcoin comprises a problem that takes an average of ten minutes to solve; with the blockchain 10 of the present disclosure, the average time required to find a solution to the problem (and the average amount of computing power required to solve the problem) may be smaller or greater.

With Bitcoin, the difficulty of the problem is dependent on the amount of computational power in the system; in particular, the difficulty is based on the average mining time of previous blocks. The difficulty of the problem of the blockchain of the present disclosure may be fixed and/or may similarly vary.

In some embodiments, the cryptographic problem has an average solution time of less than 10 minutes, less than 5 minutes, less than 3 minutes, and/or less than 1 minute. Typically, the cryptographic problem has an average solution time of less than 10 seconds, less than 5 second and/or less than 3 seconds. This enables even small parties (those with only a small amount of computing power) to find proofs in a short amount of time. Where the problem has a longer average solution time, small parties may not expect to find a proof for a large amount of time, which could discourage small parties from searching for proofs and participating in the addition of blocks. Furthermore, using a short average solution time enables an accurate determination of the present computational power devoted to the system (since there is normally only a small lag between joining the system and finding a proof).

In some embodiments, the cryptographic problem has an average solution time of greater than 10 minutes, greater than 20 minutes, greater than 30 minutes, and/or greater than 60 minutes.

Providing a problem with short solution time enables new parties to find solutions relatively rapidly and so new parties can quickly become potential proposers and validators of blocks. In contrast, providing a problem with a long solution time increases the barriers to entry into the pool of proposers and validators. Therefore, a long solution time can be used to ensure that only parties that are truly committed to the blockchain join the pool.

As mentioned above, in some embodiments there are provided a plurality of problems and/or parties are capable of selecting a difficulty of a problem to solve. For example, finding a proof may comprise finding a nonce that hashes with a block to provide a value with a number of leading zeros. Parties may be able to submit proofs with, say, 5 leading zeros and also proofs with 6 leading zeros, where the proofs with a greater number of leading zeros have a greater effect on the probability of being selected as a participant.

In some embodiments, the blockchain 10 is configured such that the problem is altered upon the finding of a proof—as an example, when a proof is submitted a new hash may be generated such that a new nonce must be found for another proof. In some embodiments, the blockchain 10 is configured such that a number of proofs may be found for the same problem (and there will typically be a number of nonces that are acceptable solutions for any cryptographic puzzle). To enable this, the proofs may not comprise an indication of the nonce.

Conventionally, consensus mechanisms based on signatures of computational power are paired with proof of work sybil-defence mechanisms. As explained previously, this leads to a blockchain that is resistant to centralisation, but has a limiting effect on the time to finality of transactions (the rate at which transactions can be added to the blockchain, validated, and reach a certain block depth). By pairing a non-SoCP consensus mechanism with a proof of work sybil-defence mechanism, a blockchain can be provided that is resistant to centralisation while providing fast finality. More generally, the resistance to centralisation of proof of work can be provided while providing benefits of other consensus mechanisms. Therefore, the proof of work sybil-defence mechanism may be paired with any consensus mechanism.

Effectively, the proof of work sybil-defence can run in the background. As opposed to Bitcoin, which uses signatures of computational power and therefore requires a proof of work problem to be solved to add a block, the present disclosure enables the mining of blocks based on solutions found to previous and ongoing proof of work problems. Therefore, the addition of blocks to the blockchain 10 is not held up by a wait for a solution to be found.

This method may be considered to be selecting a participant in dependence on a computing power devoted to a blockchain by one or more parties (e.g. potential participants). This is distinct from conventional proof of work blockchains such as Bitcoin, where a proposer is not (passively) selected. Instead, in conventional proof of work blockchains, a proposer (actively) submits a proposal based on a solution to a cryptographic puzzle.

A potential issue with the method 100 of FIG. 4, is that a party could devote computing power to the blockchain 10 for a first period of time to build up their average devoted computing power before redirecting their computing power (e.g. to another blockchain). With traditional signatures of computational power/proof of work blockchains, this redirection would result in the party no longer being able to participate in the addition of blocks (since they would not be using their computing power to search for a solution). However, with the present system, the party could re-direct their computing power while remaining in the pool of eligible/potential participants.

This issue can be addressed in a number of ways. As examples:
The computational power contribution may be determined over a limited time period, so that soon after redirecting their computing power a party is removed from the pool of eligible proposers and/or validators.
There may be a minimum recent contribution required; e.g. an average devotion may be considered over a day, where parties that have not submitted a solution to a problem relating to the blockchain 10 in the past, say, hour are removed from the pool. Such a minimum recent contribution requirement incentivizes both long-term and short-term devotion of computing power.

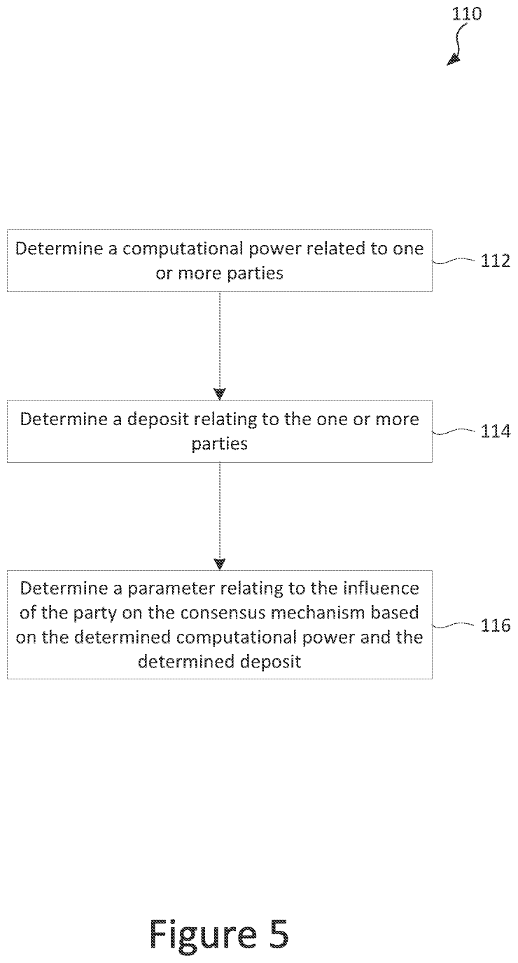

Referring to FIG. 5, there is described a method 110 of addressing the issue of redirecting computing power. As with the method 100 of FIG. 4, the method of FIG. 5 may be carried out by (the computer device 2000 of) a node of the blockchain and/or the blockchain may be configured such that the method is carried out automatically, e.g. following the addition of an nth block of the blockchain, the method may be carried out to determine a participant for the (n+1)th block. This method may be carried out by the participant of the nth block, such that the participant of the (n+1)th block is included in the nth block and/or the participant of the (n+1)th block is selected in dependence on information included in the nth block. Equally, a participant of the (n+1)th block may be selected by the nodes of the blockchain, e.g. based on information in the nth block.

In a first step 112, that is equivalent to the first step 102 of the method 100 of FIG. 4, a computational power relating to one or more parties is determined.

In a second step 114, a deposit relating to one or more parties is determined.

This typically comprises the determination of an amount of an asset (e.g. a cryptocurrency) relating to the blockchain 10 that is set aside. In particular, the parties may deposit cryptocurrency to an address and/or account of the blockchain 10 such that the deposited cryptocurrency cannot be recovered for a certain period of time. This disincentives actions that would reduce the value of the deposit.

In various embodiments, one or more of the following features is implemented:
Parties are required to deposit an asset for a certain amount of time (e.g. a certain number of blocks) before participating in a consensus mechanism and/or in the addition of a block;
Parties are unable to remove a deposit for a certain amount of time after proposing and/or validating a block;
The probability of being selected as a participant and/or the influence that a party has on a consensus mechanism is dependent on a deposit period, e.g. the likelihood of a party being selected as a proposer may be proportional to the length of time for which an asset has been deposited.

In some embodiments, the deposit may be unencumbered. A party holding an amount of the asset may be considered to be holding a deposit, where this party may be eligible for participation in the addition of a block while also being able to transfer the deposit. Typically, the party transferring the deposit results in the party no longer being eligible for participation in the addition of a block.

Typically, deposits are related to an encumbrance (e.g. the depositing party cannot easily transfer the deposit). Therefore, even if the depositing party is able to rapidly redirect their computing power, they are unable to rapidly recover their deposit. As such, this party is continuously incentivised to maintain a legitimate blockchain.

In a third step 116, that is comparable to the second step 104 of the method 100 of FIG. 4, a parameter relating to the influence of the party on the consensus mechanism is determined based on the determined computational power, and also the determined deposit.

In the above methods 100, 110, various factors have been described as being dependent on time (e.g. devoted computing power may be determined over a certain time). Equally, such factors may be determined over a certain number of blocks.

In some embodiments, proven computational power is determined based on proofs to a cryptographic problem, where the cryptographic problem depends on a block. Therefore, proofs (and/or proven computational power) may be related to a block and may only be valid for a number of subsequent blocks. In a practical example, there may be a certain problem defined by the (n−1)th block of the blockchain and a different problem defined by the nth block of the blockchain (e.g. the problem may be based on a hash relating to the block). Proofs for the problem defined by the (n−1)th block may be valid for only a certain amount of time and/or a certain number of blocks. Equally, proofs may relate to more than one block, where proofs are only valid/considered for a certain time/number of blocks after submission. For example, a proof submitted on the nth block may only affect the determined computational power for a number of blocks (e.g. until the (n+4)th block). Typically, proofs are valid for and/or affect a block period of k blocks, where k may be less than 100, less than 50, and/or less than 20. Therefore, the determination of proofs increases the probability of a party being selected as a proposer and/or validator for only k blocks (a solution relating to the nth block only has an effect up to the (n+k)th block.

The proofs may relate to a block. Equally, the proofs may be timestamped, where the proofs are only valid for a certain time period (e.g. for blocks with a timestamp within a certain time of a timestamp of the proof).

Typically, proofs to the problem are propagated to the nodes of the blockchain and/or are included in blocks of the blockchain.

In some embodiments, only the proposer of a block receives a reward (e.g. a proposing award and/or transaction fees). In some embodiments, validators receive a reward. In various embodiments:
The proposer of a confirmed block receives all the rewards related to that block.
The proposer of the block receives a portion of the rewards and the validators (and/or other participants) receive a portion of the rewards. The portions may be related to the proportion of devoted computing power and/or a deposit relating to each party. Typically, the validators receive a smaller portion of the rewards than the proposer (e.g. the proposer may receive 60% of the rewards with the remainder split between validators).
All eligible participants receive a reward. For example, each party that has devoted computing power to the blockchain may receive an award, where this reward may be dependent on the submitted computing power and/or on whether the party is selected as the participant.

As has been described in relation to FIG. 5, in some embodiments the method may comprise determining a deposit held by a party. Similarly, the reward provided to a party for proposing a block, validating a block, and/or being an eligible participant may depend on this deposit.

In such embodiments, the reward may be defined by a function ƒ (a, b), where ƒ (a, b)≥0. a is a variable relating to the devoted computing power (e.g. a proportion of total devoted computational power that is devoted by a party). b is a variable relating to the deposit (e.g. a proportion of the total deposit that is held by a party).

In particular, this function (and the associated reward) may have one or more of the following properties:
ƒ(a, b) is at a maximum when a=b. Typically, this comprises the reward being maximised when the proportion of total computational power devoted by a party is equal to the proportion of total deposit held by a party.
ƒ(a, b) is linear (in a or in b). Therefore, increasing devoted computational power and/or increasing deposit results in a linear increase in reward.

Similarly, the function may have one of the following definitions/relationships:
ƒ(a, b)∝min(a,b) (or ƒ=min(a,b)). That is, the reward is proportional to the minimum of the deposit and/or the devoted computational power. This incentivizes parties to focus on both deposit and devoted computational power.
ƒ(a, b)∝\sqrt{a·b}.

Typically, the reward is arranged to incentivise devoting a similar proportion of computational power to a deposit held by a party (e.g. having similar proportions of: total computational power (of all eligible participants) and total deposit (of all eligible participants).

Typically, the function is arranged such that a+b=constant. Equally, there may be a maximum value of the function. These implementations prevent parties from gaining undue influence by heavily investing in a single factor (e.g. a or b). In such embodiments, certificates and/or hash shares relating to the factors may be transferable, so that a party that has optimised their allocation of resources (e.g. has an equal proportion of the total computational power devoted and the proportion of total deposit held) is able to transfer a certificate relating to any excess computational power above the optimal value to another party on the blockchain 10.

In some embodiments,

$$a = \frac{{h}_{i}}{{\sum }_{j} {h}_{j}} ,$$

where n, is the computational power devoted by party x (e.g. over the last k blocks). In other words, a is determined by dividing the computational power devoted by a party by the computing power devoted by all parties.

In some embodiments,

$$b = \frac{{d}_{i}}{{\sum }_{j} {d}_{j}} ,$$

where d, is the deposit held by party x (e.g. over the last k blocks). In other words, b is determined by dividing the deposit held by a party by the deposit held by all parties.

While the above functions have considered the reward being dependent on a devoted computational power and/or a deposit held, it will be appreciated that the reward may be dependent on any combination of (at least) a computational power devoted by a party, and a deposit relating to the party.

The function may define a portion of a reward, where a value for this function can be calculated for each relevant party (e.g. the proposer and/or validators) and the reward for each party is the ratio of the value for the function of that party to the sum of the values of all calculated functions.

In a practical example, a party devotes a computational power to the blockchain 10 that is 30% of the total devoted computational power for the blockchain. This party also holds a deposit on the blockchain that is 10% of the total deposit for the blockchain. The influence of the party on the consensus mechanism of the blockchain depends on one or both of these factors. As examples:
The influence may depend on the minimum of these factors. The party might then have a 10% chance of being selected to participate in the addition of a block and/or might receive 10% of the reward of each block that is added to the blockchain.
The influence may depend on a combination of the factors. The party might then have a 17% chance of being selected to participate in the addition of a block (\sqrt{0.1×0.3}=0.17)/or might receive 17% of the reward of each block that is added to the blockchain.

It will be appreciated that these are only simple examples. The functions may be more complex and may, for example, depend on the factors (e.g. a and b) for other parties on the blockchain and/or the factors for other participants in the addition of a block.

As an example, the reward for a party i participating in the addition of a block to the blockchain may be

$${reward}_{i} = total reward * \frac{{min}_{i} ( a , b )}{{\sum }_{j} {min}_{j} ( a , b )} .$$

Here the reward is based on the minimum factor of the party i as compared to the sum of minimum factors of all parties j that have participated in the addition of the block. In this example, the participation reward is split between each party participating in the addition of the block so that a block reward is wholly distributed for each block added to the blockchain.

In a practical example of the above (where the participation reward is split between each party participating in the addition of the block), a situation is considered where two parties are eligible to participate in the addition of blocks to the blockchain 10. A first party A devotes 30% of the total devoted computational power and holds 10% of the total deposit. A second party B devotes 70% of the total devoted computational power and holds 90% of the total deposit. In this embodiment, the total devoted computational power is the total devoted computational power for eligible participants (this may differ from the total devoted computational power for all nodes of the blockchain). With this example, and normalising so that the entire block reward is distributed:
The influence may depend on the minimum of these factors. Party A might then have a 12.5% chance of being selected to participate in the addition of a block

$$( \frac{10}{10 + 70} = 0.125 )$$

and/or might receive 12.5% of the reward of each block that is added to the blockchain. Similarly, Party B might have a 87.5% chance of being selected to participate in the addition of a block

$$( \frac{70}{10 + 70} = 0.875 )$$

and/or might receive 87.5% of the reward of each block that is added to the blockchain.
The influence may depend on A combination of these factors. Party A might then have a 17.9% chance of being selected to participate in the addition of a block

$$( \frac{\sqrt{0.1 * 0.3}}{\sqrt{0.1 * 0.3} + \sqrt{0.7 * 0.9}} = 0.179 )$$

and/or might receive 17.9% of the reward of each block that is added to the blockchain. Similarly, Party B might have a 82.1% chance of being selected to participate in the addition of a block

$$( \frac{\sqrt{0.7 * 0.9}}{\sqrt{0.1 * 0.3} + \sqrt{0.1 * 0.9}} = 0.821 )$$

and/or might receive 82.1% of the reward of each block that is added to the blockchain.

In some embodiments, a certain devoted computational power and/or a certain deposit is required to participate in block generation (e.g. to be a proposer or a validator) where the reward is based on a different factor; e.g. a certain deposit may be needed to be an eligible participant with the reward being based solely on a devoted computational power.

The methods of FIGS. 4 and 5 are typically carried out by a node of the blockchain 10, where the node determines the computational power relating to the party. The node carrying out the method may, for example, be a block proposer; a block validator; and/or a block signer.

While FIGS. 4 and 5 have primarily described a method of determining a block participant based on a determined computational power, it is equally possible to determine a block participant based on another factor (e.g. the deposit held by a party) where a participation reward is based on (at least) the determined computational power. Such a method similarly incentivizes parties to provide a proof of work that increases the resistance to centralisation of the blockchain 10. More generally, any factor that has been described as affecting a reward may equally affect a probability of being selected as a block participant and any factor that has been described as affecting a probability of being selected as a block participant may equally affect a reward. Basing a reward on the devoted computational power affects the influence a party has on the consensus mechanism, not least by incentivizing potential participants to devote substantial computational power.

In various embodiments, one or more of the following is true:
The probability of being selected as a participant (e.g. the number of signatures in a DMMS) is proportional to a deposit.
The probability of being selected as a participant (e.g. the number of signatures in a DMMS) is proportional to a computational power devoted to the blockchain.
A block reward is proportional to a deposit.
A block reward is proportional to a computing power devoted in the blockchain.
A confidence weighting is proportional to a deposit. The confidence weighting may relate to the number of votes that a party has on the selection of a consensus. The confidence weighting may relate to the likelihood of a block being trusted (e.g. by the nodes of the blockchain).
A confidence weighting is proportional to a computing power devoted in the blockchain.

It will be appreciated that any combination of the above features may be implemented. For example, the probability of being selected as a proposer may depend on both a deposit and an amount of devoted computational power, while a reward may only depend on the deposit.

In some embodiments, the probability of being selected as a block participant depends on a deposit while the block rewards (e.g. a participation reward, a block reward, and/or transaction fees) are distributed between each eligible participant in proportion to the computational power devoted by that eligible participant.

In some embodiments, the computational power devoted by a party is determined before the addition of a block, e.g. based on solutions submitted in the k blocks before a current block. A participant may then be determined based on this determined devoted computational power.

In some embodiments, the computational power devoted by a party is determined after the addition of a block. Typically, this comprises a participant being determined based on a deposit and the reward then being determined based on the current block following the addition of this block to the blockchain 10.

In some embodiments, the determined devoted computational power can be used as a “confidence weighting” for the representations in the DMMS. In particular, a user of the blockchain (such as a proposer/miner/viewer on the blockchain) may distrust the DMMS on a certain block if they deem the associated devoted computational power (e.g. a computational power devoted to the block and/or a number of previous blocks) to be insufficient. In such cases, the user may wait until additional devoted computational power is evidenced before trusting a block. Therefore, the devoted computational power may act in a similar way to a block depth on a proof of work blockchain, where users are able to evaluate the devoted computational power to determine a probability that a block will not be included in an eventual longest blockchain.

This use of devoted computational power as a confidence weighting is particularly useful in embodiments where the determination of devoted computing power in the first steps 102, 112 of the methods 100, 110 of FIGS. 4 and 5 is based on an estimated devoted computational power. In particular, this first step (which occurs before the proposal of a block) may be based on the devoted computational power evidenced in previous blocks. Once the proposed block is added to the blockchain, the devoted computational power relating to that block may be evaluated to determine the confidence weighting. This can be used to ensure that a party involved in the proposal/validation of a block has not recently redirected their computational power (which could signal an attack on the blockchain is likely).

In some embodiments, a plaintext demonstration of devoted computational power is included in a block of the blockchain 10 (e.g. the block prior to the block being proposed in the methods 100, 110 of FIGS. 4 and 5). This enables a rough estimate of devoted computational power to be determined. In particular, when proofs and/or SVCs are used, there may be a super-set of merklised hash shares, where only a portion of this superset is recorded in plaintext.

In some embodiments, in order to become an eligible participant, a party is able to submit to the blockchain a claim of a proof; e.g. a party may claim to have a proof without providing evidence of the proof. This can decrease the amount of information required to become an eligible participant (where a claim might be shorter than the evidence of a proof). In these embodiments, parties are typically required to keep the evidence of the proof, where these parties may later be asked for this evidence. In particular, a node of the blockchain 10 (e.g. a node proposing a block) may be able to request evidence of a proof from a party. This may comprise the node being arranged to randomly (and/or periodically) request evidence of proofs. Parties that do not provide evidence following a request may be penalized (e.g. by being prohibited from being a participant for future blocks or by having an amount of an asset relating to the blockchain (e.g. the deposit) permanently locked on the blockchain or transferred to another party).

A similar consideration may be used for blockchains that consider multiple sybil-defence mechanisms. For example, a blockchain may be arranged to use a proof of stake sybil-defence mechanism as well as a determination of devoted computational power (and hence a proof of work sybil-defence mechanism). In such a blockchain, a block may conventionally be added to the blockchain when the participants (e.g. validators) of the block hold a certain deposit. According to the present disclosure:
The addition of the block may also require the participants to devote a certain computational power (e.g. a certain proportion of the overall devoted computational power).
There may be an indication provided where the participants do not devote a certain computational power, where the block may still be added to the blockchain based on the deposit. For example, there may be a flag placed in a block before the block is added to the blockchain and/or an indication (e.g. an alarm) may be transmitted to a node of the blockchain. This can lead to the node carefully examining the block and/or refusing to validate the block.

Typically, it is easier to attack a proof of stake sybil-defence mechanism than a proof of work sybil-defence mechanism, so a block may be added to the blockchain based on the proof of stake threshold but not fully trusted until the proof of work threshold is reached. Therefore, a node may be arranged to identify whether the proof of stake threshold and/or proof of work threshold has been exceeded and/or to output an indication of the whether each threshold has been exceeded. This indication may comprise a flag in the block of the blockchain and/or a message to a node of the blockchain.

It will be appreciated that various types of sybil-defence mechanisms may be used within the determination of the parameter. For example, proof of work, proof of stake, proof of history, proof of activity, etc.

The distribution of rewards may be arranged such that the entirety of the rewards for a block are distributed when each block is added to the blockchain 10. Alternatively, the blockchain may be configured so that an amount of the reward (e.g. the transaction fees) may be added to a subsequent block depending on the deposit/devoted computational power of the parties to the blockchain at the time of adding a block. In particular, if the proposer and validators of a block have not allocated resources efficiently (e.g. have similar proportions of computing power devoted and deposit held), an amount of the reward may be rolled over to a subsequent block. This prevents parties to the blockchain colluding to split resources inefficiently (as may occur when the entirety of the block reward is always distributed).

Embodiments where the probability of being a participant and/or the distributed reward is dependent on a deposit can be beneficial since it provides a risk-free return for depositors. This encourages parties to deposit in the blockchain 10, thereby growing the user base of the blockchain. Selecting a participant in dependence (also) on the computing power enables this risk free return while incentivizing the contribution of computing power and avoiding centralisation.

The above description has related to a reward and/or a probability of participation being determined based on a determined (e.g. devoted) computational power. More generally, a parameter may be determined based on this determined computational power, where the parameter may relate to a reward for a party and/or the probability of a party being chosen to participate in the addition of a block of the blockchain 10.

Yet more generally, an influence of the party on a consensus mechanism of the blockchain may depend on the determined (e.g. devoted) computational power. The influence of a party may relate to one or more of:
The eligibility of a party to be selected to participate in building a consensus on a history of the blockchain.
The eligibility of a party to be selected to participate in the addition of a block to the blockchain.
The degree of active participation of the party in building a consensus and/or adding a block. This degree may relate to a number of votes that the party contributes in relation to the building of a consensus history. Another example of defining the degree of active participation of a party is defining whether the party is a proposer and/or a validator for a block (where a validator may be considered to have less influence and/or may receive a smaller reward).
A weighting of signatures and/or a weighting of contributions to the DMMS.
A weighting of instances of participation and/or contributions to the building of consensus.
The reward received by a party for being eligible to participate and/or active participation in building a consensus and/or adding a block to the blockchain.
A confidence weighting and/or a participation weighting. In particular, the eligibility to participate in the building of a consensus and/or the addition of a block may depend on deposit alone, while the weighting of each parties vote may depend on the devoted computational power of that party. In some embodiments, building consensus may involve summing a parties signatures in the DMMS and weighting these based on that party's computational power.

Where the description describes a parameter altering the eligibility to participate and/or the maximum degree of participation of the party, it will be appreciated that more generally the parameter may alter the influence of the party on a consensus mechanism.

Equally, the parameter may alter the reward received by a party for the addition of a block to the blockchain (whether or not that party is an active participant in the addition). This alteration of reward is related to (and included in) the alteration of the influence of a party on the consensus mechanism, since the alteration of the reward affects the motivation of a party to participate in a sybil-defence mechanism (which sybil-defence mechanism affects the building of a consensus, e.g. by altering the eligibility of parties to participate in building a consensus).

Not least due to this, each part of this description that describes the parameter relating to the influence of a party on the consensus mechanism should also be taken to describe the possible use of the parameter to alter a reward received by a party. For example, the second step 104 of FIG. 4 has described the devoted computational power as affecting the influence of the party on the consensus mechanism; in particular, this has been described in light of a probability of being selected to participate in the building of consensus being dependent on the devoted computational power. Equally, a reward received by the party may be dependent on the devoted computational power (the reward may relate to the addition of a block to the blockchain and this reward may be received whether or not the party has actively participated in the addition of that block).

In some embodiments, a party is eligible to participate in the building of a consensus only if the party has devoted computational power to the blockchain (and/or only if the party has devoted sufficient computational power). The party may then, if selected, choose to actively participate in the building of a consensus (e.g. to be an active participant) or choose not to actively participate in the building of consensus. Either way, the influence of the party on the consensus mechanism will be dependent on the computational power devoted by that party (since this devotion gives the party the option to actively participate, if and when the party is selected). It will be appreciated this eligibility may also depend on other factors, such a deposit held by the party (as is described above).

Typically, parties are able to choose whether or not to be an active participant. Devoting computational power may result in a party becoming an eligible participant, and possibly being selected to participate; however this party may be able to choose not to actively participate in the building of a consensus and/or the addition of blocks. Equally, this party may be prohibited from such active participation (e.g. a party may be prohibited from actively participating in the building of consensus on blocks containing transactions involving that party or a party may become inactive due to connectivity issues). Generally, a party that is an eligible participant may be either an active participant or an inactive participant, where only eligible participants may have a chance of being selected to participate in the building of a consensus and/or the addition of blocks. Eligible participants may become active participants when they are selected to participate in the building of a consensus and/or the addition of blocks. Equally, eligible participants may become active participants when they agree to participate in the building of a consensus and/or the addition of blocks (e.g. after they have been selected as a participant). Normally, for any given block only a subset of the eligible participants are selected participants.

Typically, all eligible participants receive rewards relating to the addition of blocks to the blockchain. In some embodiments, only selected participants or only active participants receive such rewards.

In some embodiments, the parameter is related to a maximum probability of being selected to participate and/or a maximum degree of active participation. In particular, the probability of a party being selected to participate in the addition of a block may increase as that party devotes an increasing amount of computational power to the blockchain. However, the party may still choose not to actively participate (i.e. not to be an active participant) in the addition of blocks (e.g. they may have no active participation in the addition of blocks). This party may still receive rewards for the addition of blocks due to being an eligible participant (even if the party is not selected to participate and/or an active participant).

The possible roles of the party may depend on the devoted computational power; for example, a first level of devoted computational power may be needed to be eligible to validate a block, while a second, greater, level of devoted computational power is needed to be eligible to propose a block.

In some embodiments, the probability of being selected to participate in the addition of a block is largely dependent on a deposit (and/or only dependent on a deposit) held by a party. This may enable parties that devote only a small amount of computing power to the blockchain to become active participants in the addition of a block. The influence of these parties, and/or a weighting of signatures for these parties, may still relate to the devoted computing power. Therefore, parties with a small devoted computing power may be able to actively participate in the addition of blocks, while having a smaller influence on the consensus mechanism—e.g. these parties with a small devoted computing power may contribute fewer votes to the building of a consensus than parties devoting a greater computing power.

It will be appreciated that selection for participation as determined by a node carrying out the method 100 of FIG. 4 or the method 110 of FIG. 5 typically relates to an expected degree of selection for participation, so that the determination of a probability of selection for participation typically relates to a probability that the party is selected for participation for a future block of the blockchain. Similarly, the reward determined by the node typically relates to an expected reward, where the reward relates to a future block of the blockchain. An actual reward may differ from the expected reward (e.g. due to statistical fluctuations in the number of times an eligible participant is selected to participate.)

Multiple Blockchains

While the above description has considered combining any consensus mechanism with a proof of work sybil-defence mechanism on a single blockchain, a similar method may be applied to a system comprising a plurality of blockchains. In particular, a similar method may be applied to a system comprising at least one blockchain with a proof of work sybil defence-factor, such as Bitcoin and/or Bitcoin SV, and at least one blockchain with a proof of stake sybil-defence mechanism. It will be appreciated that other systems may also be used. Typically, at least one of the blockchains uses a proof of work sybil-defence mechanism.

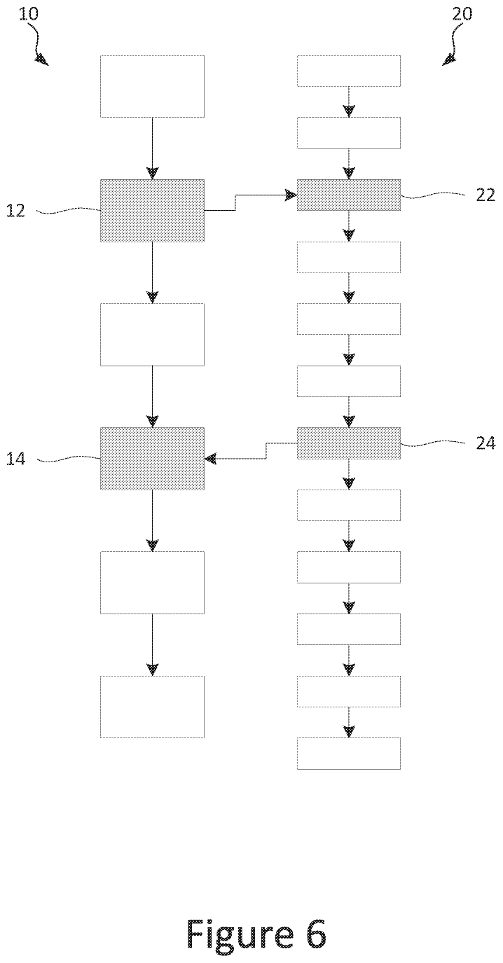

Referring to FIG. 6, there is shown a system comprising the blockchain 10 (the ‘main chain’) and a second blockchain 20 (the ‘side chain’). Each blockchain comprises a plurality of component blocks, where each block comprises a number of entries, such as transactions. Typically, each blockchain has a related cryptocurrency (such as Bitcoin or Algorand), where the entries on the blockchain comprise transactions made using that cryptocurrency; hereafter these are referred to as a ‘first cryptocurrency’ (for the main chain) and a ‘second cryptocurrency’ (for the side chain). An amount of cryptocurrency may be transferred in the form of a ‘token’, where a token may be worth, for example, an amount of Bitcoin or Algorand.

Information relating to the side chain 20 (e.g. a hashed value of the side chain at a given block of the side chain and/or the entirety of one or more blocks of the side chain) may be recorded on the main chain 10.

This being the case, the side chain can benefit from the security of the main chain. In the event that the side chain is compromised after the recording of information on the main chain, there remains an immutable record of a portion of the side chain on the main chain. This enables the identification of altered blocks by comparison of the side chain to a record of the side chain stored in the main chain. If an attack on the side chain is identified, the storage of relevant information on the main chain also enables the side chain to be forked from a ‘legitimate’ (e.g. unaltered) block that is stored on the main chain. It will be appreciated that the main chain can be continuously updated (e.g. each block) with a record of the transactions and/or blocks of the side chain, so as to minimise the opportunities for the side chain to be attacked.

The side chain arrangement enables advantages of the main chain and/or an existing chain to be attained (e.g. security and extant miners) while enabling the use of other blockchain technologies that have their own advantages (e.g. faster time to finality). Furthermore, in the event that the side chain is compromised, the main chain can remain secure.

However, the arrangement is not without flaws. In particular, it is important to keep miners incentivised to mine both chains. If a significant amount of activity starts to occur on a side chain, it might become more profitable for miners to focus on that side chain to the detriment of the main chain. This could allow a successful 51% attack on the main chain with negative effects for both of the main chain and the side chain.

A possible solution to this incentivization problem is ‘merge mining’. With merge-mining, the solution to the cryptographic puzzle for a side chain is related to the solution for the main chain. As an example, the side chain 20 may use the same hashing algorithm as the main chain 10, but require a lower difficulty solution. Where the main chain is Bitcoin, a hash solution for the main chain may require p leading zeros to be valid;

the side chain may then require a hash solution to be found that has p-q zeros, where q<p. Therefore, miners can mine both the main chain and the side chain; side chain validations typically occur more frequently (and so transactions are typically added to the side chain more frequently) and periodically a miner will find a solution that is acceptable for both the main chain and the side chain (and be doubly rewarded).

This largely solves the problem of miners focusing on the side chain and neglecting the main chain (since it is quite simple mining both chains simultaneously); however, merge-mining is far from a perfect solution. As an example, with merge-mining the side chain must use a similar (but typically lower difficulty) cryptographic problem to the main chain; this severely limits the types of blockchain that can be used as a side chain.

The present disclosure relates in part to a method of rewarding parties in which the reward for a party for participating in the addition of blocks to a first blockchain is based on the party's participation and/or activity on a second blockchain (e.g. the reward for mining a block on the side chain is based on the participation of the miner on the main chain). This solution enables the use of a wide range of types of blockchain for the side chain.

Equally, the probability of a party being selected for participation in the addition of blocks to a first blockchain may be based on the party's participation and/or activity on a second blockchain.

Even more generally, any parameter relating to the participation of the party in the addition of blocks to the first blockchain may be based on the party's participation and/or activity on a second blockchain

As with the main chain 10, methods of configuring, adding to, accessing, and viewing the side chain 20 are typically performed using the computer device 2000.

The ‘activity’ of a party on a blockchain (e.g. the activity on the second blockchain) typically relates to that party's contribution to a sybil-defence mechanism of the blockchain. More generally, activity may relate to a party's involvement on the blockchain (e.g. their involvement in building a consensus on the first blockchain). For example, the activity of a party on the second blockchain may relate to:
A computational power devoted by the party to the second blockchain (e.g. a contribution to a proof of work sybil-defence mechanism of the blockchain).
A deposit held by the party in relation to the second blockchain (e.g. a contribution to a proof of stake sybil-defence mechanism of the second blockchain).
A participation of the party in the addition of a block to the second blockchain.
A signature relating to the party in a DMMS of the second blockchain.

Block Addition

To record entries on each blockchain 10, 20, parties propose and/or ‘mine’ blocks, where each block contains a number of entries. As has been described above, the proposal of a block on one of the blockchains typically results in the proposer receiving a reward, where this reward is typically an amount of the cryptocurrency relating to the blockchain being mined—this reward may comprise a ‘block reward’, which is a fixed amount for proposing the block and/or transaction fees, relating to the transactions contained in the proposed block. The reward (and the party collecting the reward) is typically recorded in the block that has been proposed.

With conventional blockchains, the proposing reward is the same regardless of which party has proposed the block. More specifically, the reward is conventionally not dependent on any external feature to the blockchain being added to/mined and depends only on the blockchain being added to/mined and the transactions within the block being proposed. This being the case, each party might be incentivised to propose/mine blocks only on the blockchain with the highest reward per unit of devoted computational power.

In order to incentivise participation on both of the main chain 10 and the side chain 20, there is disclosed herein a method of determining a parameter relating to the influence of a party on a consensus mechanism of a first blockchain based on the activity of the party on a second blockchain. In particular, the participation reward for a party may be determined in dependence on the activity of that party on another blockchain; e.g. the reward for participating in the addition of a block of the side chain may depend on the participation and/or activity of the party on the main chain.

As described above, it is desired to incentivise parties to participate in the addition of blocks, and/or the building of consensus, on each of the main chain 10 and the side chain 20. This incentivization may be achieved by providing a participation reward, where the participation reward depends on the activity of the party on the chain which is not being added to.

In order to determine a suitable reward for a miner or proposer of a block on the side chain 20, in order to determine the probability of a party being selected as a participation for a block on the side chain, and/or, more generally, in order to determine an influence of the party on the consensus mechanism of the side chain, a parameter relating to the influence is determined based on the activity of that party on the main chain 10. The parameter may affect one or more of: a block fee, a transaction fee, and/or a probability of being selected as a participant for a subsequent block.

In some embodiments, the parameter is associated with the probability of a party participating in the addition/generation of a block of the main chain 10. For example, as the parameter may be based on the probability of the party proposing the next block on the main chain. This parameter may then affect a reward for the party for proposing a block on the side chain 20.

In blockchains using a proof of work sybil-defence mechanism (e.g. Bitcoin), the probability of any given party finding a suitable nonce depends on the ratio of a party's devoted computational power (e.g. hash rate) to the total devoted computational power of all parties attempting to find a suitable nonce. Therefore, the parameter determined with a proof of work system (e.g. a conventional proof of work system that is based on a signatures of computational power consensus mechanism) may be the ratio of the computational power devoted by a party to the total devoted computational power of all parties of the blockchain in question. This ratio and/or the parameter may be determined by determining a number of blocks mined by the party in a certain time period (e.g. the number of blocks mined by this party in the last 10000 blocks, last 5000 blocks, and/or last 1000 blocks). This may involve evaluating the signatures of computational power for these previous blocks.

In blockchains using a proof of stake sybil-defence mechanism, the probability of a party being chosen to participate in the addition of a block is instead dependent on the stake held/deposited by the party (e.g. a deposit of the party). Therefore, the parameter used may be the ratio of the deposit of the party in relation to the side chain 10 to the total deposits by all parties for the side chain 20. Similarly, the parameter may be determined by determining a number of blocks for which the party has been a participant (e.g. the number of blocks including this party as a participant in the last 10000 blocks, last 5000 blocks, and/or last 1000 blocks).

By basing the participation reward and/or the probability of being a participant for a block of the side chain on activity on the main chain 10, an effective pairing between consensus mechanisms and sybil-defence mechanisms can be achieved. This can be explained using an example where the consensus mechanism of the main chain is based on signatures of computational power, the main chain uses a proof of work sybil-defence mechanism, and the consensus mechanism of the side chain is based on a non-SoCP consensus mechanism (e.g. signatures of knowledge). Here a parameter can be determined based on the activity of a party on the main chain, where this activity relates to the contribution of a party to the proof of work sybil-defence mechanism. The probability of this party being selected to participate in the addition of a block to the side chain (and/or the reward for this party for participating in the addition of a block to the side chain) may then be dependent on this parameter and thus dependent on a proof of work sybil-defence mechanism. The side chain may thus obtain the benefit of a proof of work sybil-defence mechanism while also obtaining the benefit of a non-SoCP consensus mechanism (e.g. a rapid time to finality for blocks).

By using this arrangement with a plurality of blockchains, an existing main chain 10 can be combined with a separate and/or new side chain 20 to achieve the benefits of the pairings of consensus mechanisms and sybil-defence mechanisms. This enables a side chain to be configured that benefits from this pairing and also benefits from the security established by an established main chain (e.g. Bitcoin). The main chain typically does not need to be modified or reconfigured, which is beneficial since modification might be difficult.

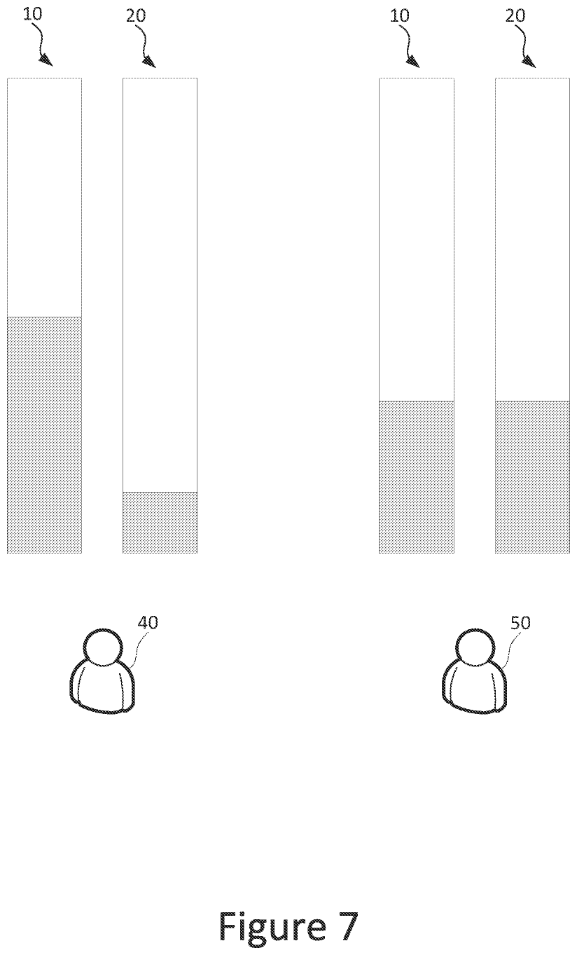

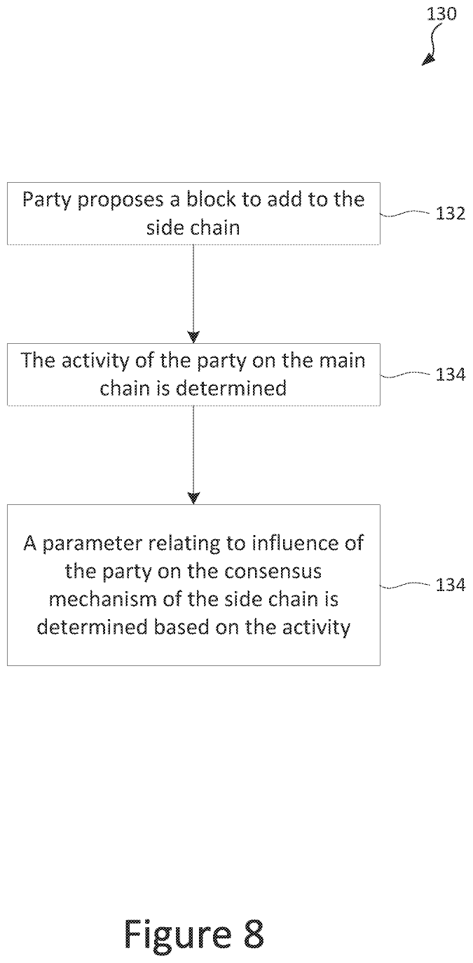

An exemplary usage of a parameter is described with reference to the system of FIG. 7 as well as the flowchart of FIG. 8. In the exemplary system of FIG. 7, a first party 40 controls 50% of the total hash rate (e.g. the total computational power) of the main chain 10 and holds a 10% stake on the side chain 20. A second party 50 controls 30% of the total hash rate of the main chain and holds a 30% stake on the side chain 20. In this example, the proposer of a block for the main chain 10 conventionally receives a block reward of ten units of a first cryptocurrency (‘CryptoA’) and the proposer of a block for the side chain 20 conventionally receives a block reward of ten units of a second cryptocurrency (‘CrytpoB’). It will be appreciated that in practice a party controlling 50% of the total hash rate for a blockchain is typically undesirable.

In conventional blockchains, a party proposing a block for the side chain 20 would receive ten units of CryptoB regardless of the activity of that party on the main chain 10. As such, this party may focus their attentions solely on the side chain to maximise their attainment of CryptoB. Therefore, in order to incentivise adding to/mining of a main chain, the side chain is configured such that the reward for proposing a block of the side chain is dependent on a parameter determined based on activity on the main chain 10. In this example, if the first party 40 proposes a block of the side chain 20, they may receive a reward equal to 0.5×10=5 units of CryptoB (0.5 being a parameter associated with the activity of the first party on the main chain 10). Similarly, the second party 50 may receive a reward equal to 0.3×10=3 units of CryptoB when the second party proposes a block of the side chain 20.

In this example, despite the second party 50 holding three times the deposit of the first party 40 on the side chain 20, the expected reward of the second party 50 (3 units×0.3 chance of proposing a block=0.9 unit reward expectation) is less than double than the expected reward of the first party 40 (5 units×0.1 chance of proposing a block=0.5 unit reward expectation). Assuming the reward on the main chain 10 is not affected by activity on the side chain 20, the first party 40 will have a higher expected reward for adding to/mining the main chain 10 that might make up for the decreased expectation on the side chain 20. The implementation of a weighted reward is thus usable to incentivise participation/activity on the main chain 10.

It will be appreciated that this is only an exemplary use of the parameter and other uses of the parameter are envisaged. As an example, the reward for a party proposing a block of the side chain may be dependent on a minimum activity on the main chain 10 and the side chain 20. With this example, the first party 40 may receive a reward equal to 0.1×10=1 units of CryptoB for proposing a block of the side chain (min(0.1, 0.5)=0.1). Similarly, the second party 50 may receive a reward equal to 0.3 c 10=3 units of CryptoB when the second party proposes a block of the side chain. Here the parameter is based on the activity of each party on the side chain as well as the activity of each party on the main chain.

Furthermore, as with the single blockchain, the reward function may be arranged to ensure that the entirety of the block rewards are distributed, so the functions for each party may be normalised. Considering still the use of a minimum function, the first party 40 may receive a reward equal to 2.5 units CryptoB when a block is proposed on the side chain

$$( 10 * \frac{min ( 0.1 , 0.5 )}{min ( 0.1 , 0.5 ) + min ( 0.3 , 0.3 )} = 2.5 )$$

and the second party may receive a reward equal to 7.5 units of CrytoB when a block is proposed on the side chain

$$10 * \frac{min ( 0.3 , 0.3 )}{min ( 0.1 , 0.5 ) + min ( 0.3 , 0.3 )} = 7.5 .$$

It can be seen that this incentivizes a split of resources between the two chains.

In some embodiments, parties are incentivised differently, where instead of (or additionally to) the reward for participating in the addition of a block being directly dependent on the parameter, the probability of participating in the addition of a block of the side chain 20 is dependent on a parameter based on activity on the main chain 10. More generally, using the parameter the influence of a party on the consensus mechanism of the side chain may be based on the activity on the main chain (further examples of varying the influence of a party on a consensus mechanism have been described above).

Referring to FIG. 8, a method 130 of determining a parameter relating to the influence of a party on the consensus mechanism of the side chain 20 (e.g. a participation reward and/or a participation probability) is described, where this parameter is based on an activity of the party on the main chain 10.

In a first step 132, a party proposes a block to add to the side chain 20. This may comprise the party proposing a block with a valid nonce on a proof of work chain or a party being selected as a block proposer on a proof of stake chain.

In a second step 134, the activity of the party on the main chain 10 is determined. This typically comprises determining at least one of:
A deposit held by the party in relation to the main chain 10. This may be a deposit of the first cryptocurrency and/or the second cryptocurrency, where the deposit may be deposited in a manner such that the party cannot freely spend the deposit.
A computational power/hash rate devoted by the party to the main chain. This may comprise determining the hash rate devoted by the party in relation to a total hash rate for the system at a given point in time. As estimation of the devoted computational power may rely on an evaluation of public databases and/or the consideration of proofs recorded on the blockchains 10, 20 and/or submitted to the nodes of the blockchains (as described with reference to the methods 100, 110 of FIGS. 4 and 5).
A historic participation rate and/or a historical devotion of computational power. This may comprise identifying a number of blocks that have previously been proposed by the party. This may be useable to prevent a party from accruing a large deposit and/or hash rate for a small amount of time and thereby attacking the system. Similarly, a historic deposit and/or hash rate may be determined.
A time profile for the activity of the party. Typically, this comprises determining the length of time for which a certain deposit has been held or a certain computational power has been devoted by the party. This determination of the activity encourages long-term commitment from the party.

It will be appreciated that these factors may similarly be considered in the single blockchain system described with reference to FIGS. 1-4. Equally, those factors described with reference to the single blockchain system may be considered for use with a multi-blockchain system.

In a third step 136, a parameter is determined relating to the influence of the party on the consensus mechanism of the side chain, where the parameter is dependent on the activity of the party on the main chain. The determination of activity has been described above, and in relation to FIG. 7. The influence of the party on the consensus mechanism is typically related to one or more of:
The probability of the party being selected to be a proposer and/or validator for a block of the side chain 20.
The reward that the party obtains for proposing and/or validating a block of the side chain 20.

Typically, the reward for participating in the addition of a block comprises both a set block reward and variable transaction fees, where the transaction fees depend on the block being mined. The block reward may reduce as more blocks are added to the side chain 20 (e.g. the block reward for mining Bitcoin halves every 210,000 blocks) so that the transaction fees comprise a greater proportion of the reward. This can lead to a situation where miners are incentivised to fork the chain in an attempt to gain greater transaction fees—such an attack is described in “Block rewards vs transaction fees (undercutting): Miles Carlsten, Harry Kalodner, S Matthew Weinberg, and Arvind Narayanan. On the instability of bitcoin without the block reward. In Proceedings of the 2016 ACM SIGSAC Conference on Computer and Communications Security, pages 154-167, 2016”.

The disclosed method can avoid this issue, by providing a reward that is not primarily dependent on the transaction fees of the chain being mined. This provides party with a continuous incentive to participate in the addition of blocks (as opposed to an incentive to wait until transaction fees have reached a certain level).

Again referring to the exemplary system of FIG. 7, the second party 50 holds a 30% deposit on the side chain 20 and so might expect to be selected to propose 30% of new blocks. However, due to controlling only 30% of the hash rate on the main chain 10, the second party may be selected to propose only 30% of new blocks on the side chain. Conversely, while the first party 40 only holds a 10% deposit on the side chain, due to holding 50% of the hash rate for the main chain, the first party may be selected to propose 50% of new blocks on the side chain. The implementation of this only requires adherence from the side chain, where the side chain could select proposers of a new block based on the parameter associated with activity on the main chain. In this example, an implementation is used that does not require action of the main chain (so that an extant main chain, such as Bitcoin, could be considered without modification).

Of course, the above are only simple examples, the link between the parameter and the influence and/or reward may be more complex, for example the reward may depend on a parameter that is based on activity on both the main chain 10 and the side chain 20, e.g. the reward may depend on an average activity and/or a function of activities.

The relation between the parameter of the main chain 10 and the reward/probability of being a participant for a block of the side chain 20 may be based on one or more of:
A minimum activity.
An average activity.
A normalised activity.

The examples described with reference to FIG. 7 have considered a system with only two parties 40, 50 and with only two blockchains 10, 20. Generalizing further, the reward system may be implemented in a system with N subsystems (where these subsystems are typically blockchain systems and/or public consensus networks) and with a multitude of parties.

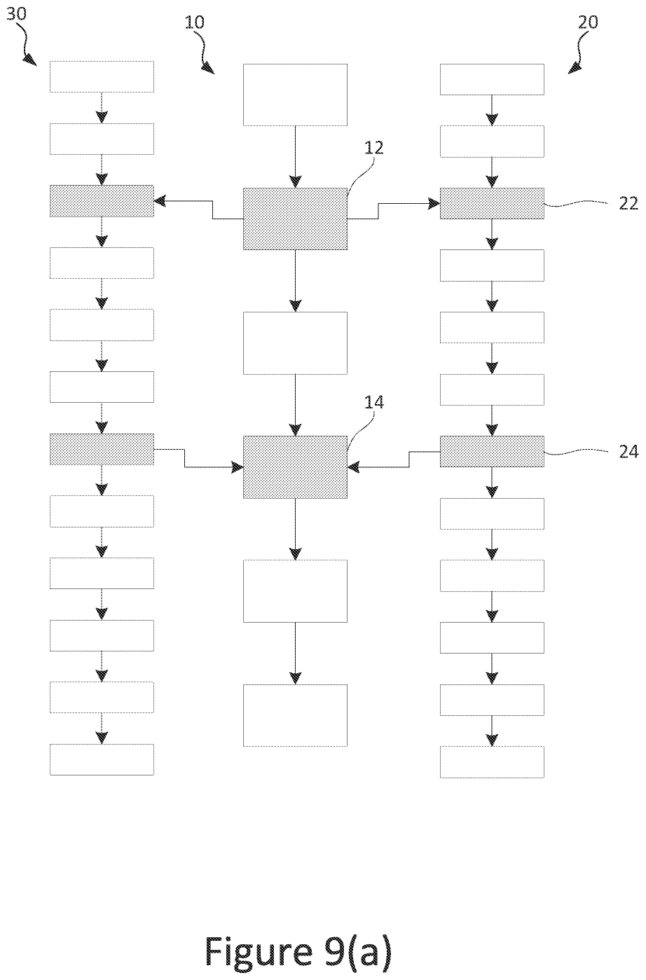

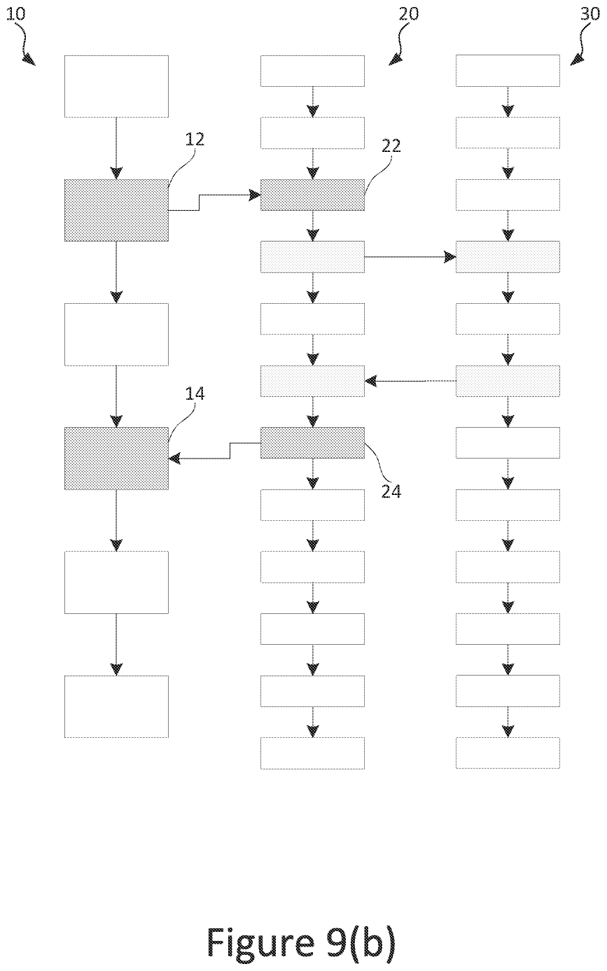

Examples of systems with three chains are shown in FIGS. 9a and 9b; these systems each comprise the main chain 10, the side chain 20, and a third chain 30.

As examples:
The parameter (that effects a party's influence on the consensus mechanism may depend on a plurality of chains in a system. For example, the reward for participating in the addition of blocks to the main chain 10 may depend on the activity of the party on both the side chain 20 and the third chain 30.
There may be a plurality of parameters determined, with each parameter relating to the party's influence on the consensus mechanism of a different chain.
   For example: there may be a first parameter determined for the party's influence on the side chain where this first parameter depends on activity on the main chain 20 and the third chain 30; and there may be a second parameter determined for the party's influence on the third chain, where this second parameter depends on the party's activity on the main chain and the side chain. With this arrangement, participants on the third chain are incentivised to be active on the side chain and the main chain and participants on the side chain are incentivised to be active on the main chain and the side chain. Such an arrangement is particularly applicable where the main chain is an established blockchain, and the two side chains are newer blockchains.
   Equally: there may be a first parameter determined for the party's influence on the side chain 20, where this first parameter depends on activity on the main chain 10; and there may be a second parameter determined for the party's influence on the third chain 30, where this second parameter depends on the party's activity on the side chain. With this arrangement, participants on the third chain are incentivised to be active on the side chain and participants on the side chain are incentivised to be active on the main chain (but participants on the side chain are not incentivised to be active on the main chain). Such an arrangement is particularly applicable where the main chain is an established blockchain, the side chain is a newer blockchain, and the third chain is a yet newer blockchain.
   Equally, the parameter for each blockchain may depend on the party's activity on each other blockchain.

Certificates

In many cases, computing hardware may be optimised to mine a certain sort of blockchain. This is especially true of application specific integrated circuits (ASICs) which are a major source of hash rate for Bitcoin mining, but are of less benefit for other uses (indeed, Ethereum actively works to reduce the effectiveness of ASICs). Not least due to this, in some embodiments it is possible to transfer certificates relating between parties, which certificates affect the determination of the parameter. In order to achieve this, parties may be able to obtain evidence (e.g. certificates) relating to their devoted computational power on a given blockchain. In some embodiments, eligible participants for a blockchain are able to receive a certificate that is useable to supplement the parameter for that blockchain, such certificates may be received instead of, or as well as, a block reward. In some embodiments, parties are able to redeem a portion of their devoted computational power in return for a certificate. On a proof of stake system, a party with 10% of the total deposit of the side chain 20 may have a 10% parameter associated with participation on the main chain 10 (e.g. a 10% chance of being selected to propose a block). Where certificates are used, this miner is typically able to trade a portion of this probability for a certificate—so that the miner can, with the same deposit, have a 5% parameter associated with participation on the main chain and a certificate for a 5% computational devotion. This certificate may then be traded with another party (e.g. a party with a less substantial deposit on the side chain).

Typically, certificates may be transferred and are then ‘consumed’ during the determination of the parameter. Certificates may be valid for the determination of only a single parameter, may be valid for the determination of multiple parameters (e.g. for a number of blocks of the blockchain), or may be traded for an indeterminate and/or unlimited time period. For example, mining pools that are active wholly on a single one of the chains may agree to trade certificates with mining pools active on the other chain so that both mining pools maximise their rewards.

The use of certificates also allows an evaluation to be made regarding the activity of a party on each chain. In this regard, it can be difficult to determine, for example, the proportion of a participant's hash rate to the network hash rate. Generating certificates in relation to past activity provides a method of determining the activity of a party at the time of adding a block (as a certificate for the main chain 10 can be presented as part of the addition process for a block on the side chain 20 to evidence activity on the main chain 10).

Since the probability of any given party participating in the addition of a block may be quite small, certificates may be issued to/issuable from pools of participants, which pools are more likely to participate in the addition of a block. In practice, mining pools comprise a large portion of the network hash rate for most proof of work systems; certificates may be issued to mining pools upon mining of a block, where the mining pool then distributes these certificates among the constituent miners in proportion to the hash rate committed by each party.

In various embodiments, the certificates have a limited lifespan and/or are tradeable to a subset of other parties. Limiting the tradability of certificates may be of some value in dissuading large mining pools. Pools which control a certain percentage of a factor (e.g. computational power or deposit) for one of the blockchains may be prevented from obtaining certificates relating to the other blockchains. This encourages the formation of a greater number of smaller pools that can trade more freely. This might be used to guard against 51% attacks.

The certificates may each have the same value and/or the certificates may each be associated with a value.

This value may be considered during the determination of a parameter (or a factor), where the parameter may (for example) be determined based on the value of the certificates held by a node divided by the value of all of the certificates in the network.

Typically, certificates are one or more of:
Fungible (e.g. the certificates are mutually exchangeable).
Transferrable (e.g. the certificates can be transferred between nodes of the blockchain and/or more generally between two parties).
Time limited. Typically, the certificates are time limited so that the resource and/or the contribution of a node to a sybil-defence mechanism needs to be frequently “reproven”. For example, a certificate may be issued to a node based on the computational power devoted by that node in association with a block n of the blockchain 10 and this certificate may be valid only until block n+5. This incentivizes nodes to provide a continuous contribution to a sybil-defence mechanism.
Limited. For example, certificates may be limited to a certain geographical location and/or a certain purpose. Placing a limit on certificates can be used to prevent one node purchasing numerous certificates in order to obtain a large amount of influence over the consensus mechanism of the blockchain 10. The limitations may be dependent on the blockchain (where the blockchain may be configured so that certain certificates are associated with limitations, and the methods disclosed herein may comprise the determination or identification of a limitation of a certificate). Limitation may relate to the certificates being arranged so that the certificates can only be held by, transferred to and/or from, and/or received by certain nodes.
In various embodiments, certificates are limited by one or more of:
   Supply. There may be a limited number of certificates in circulation at any time, where certain certificates (e.g. the oldest certificates) may be arranged to expire if this limit is exceeded.
   Owner. Only certain nodes may be able to hold, transfer and/or receive certificates. In particular, only nodes that are associated with a contribution to a sybil-defence mechanism that is beneath a threshold contribution may be able to receive certificates associated with this sybil-defence mechanism from other nodes. This prevents centralisation of the sybil-defence mechanisms. Equally, there may be provided a whitelist and/or a blacklist of owners so that nodes that have behaved poorly in the past (e.g. nodes that have attempted to record a fraudulent transaction) are unable to receive certificates.
   Location. For example, certificates that are issued to a node located in a first continent may be transferrable only to other nodes in that continent. This can also help to prevent centralisation.

A plurality of types of certificate may be used. For example, the different types of certificate may be associated with:
Ownership (e.g. outright possession/control of a resource by a node, which resource is associated with a sybil-defence mechanism).
Lease (e.g. a paid arrangement for a node to use, or benefit from, the resource).
Delegated (e.g. authorised use of, or benefit from, the resource by a node, without the node taking control of the resource).
Repurchase agreement (e.g. ownership of the resource being transferred to a node by being sold, with a binding agreement from the node to sell the resource back at some later time).

A type of certificate may be recorded on the certificate itself (e.g. the blockchain 10 may store a record of the certificates associated with each node alongside a type of certificate). Equally, there may be a single type of certificate, where the nodes may be able to lease, delegate, etc. these certificates based on agreements that are outside of the scope of the blockchain.

The issuing of certificates typically requires an entity to verify the contribution of a node to a sybil-defence mechanism. With the example of a proof of work sybil-defence mechanism, the issuing of certificates is typically based on the submission of hash shares to a share verification contract (SVC). This submission may result in a number of certificates being issued to the node.

Typically, the ‘entity’ comprises a smart contract, where this smart contract may be implemented on the blockchain 10. Equally, the entity may comprise a controlling authority—and with such an implementation the certificates may be used as part of a centralized blockchain.

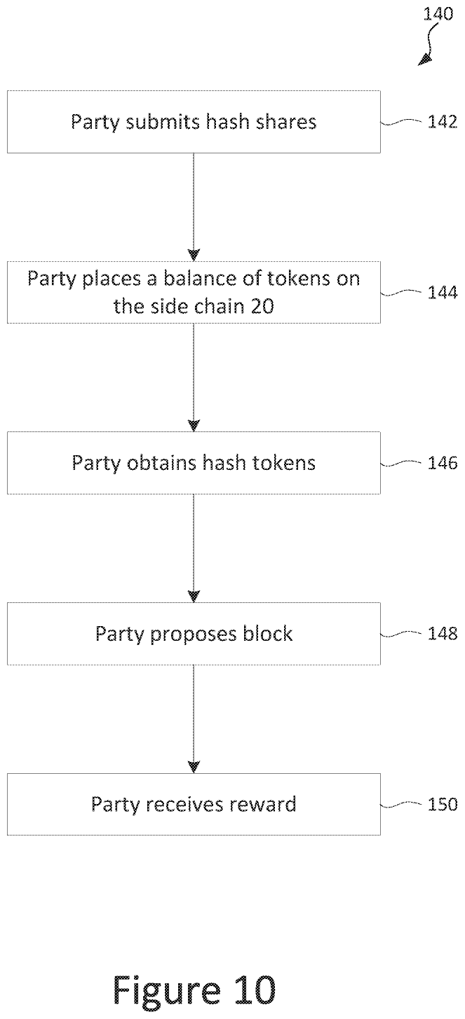

An example of the use of the disclosed methods is described with reference to FIG. 10.

In a first step 142, the first party 40, which is proposing blocks for the main chain 10, submits hash shares to a share verification contract (SVC). In return the first party receives hash tokens (certificates) in proportion to the number of hash shares that have been submitted. In this example, the SVC runs on the side chain 20 and the hash tokens are transferable between accounts on the side chain. The certificates can be traded to another entity, which is not mining a substantial amount of blocks on the main chain.

Typically, this first step comprises two sub-steps. In particular, in a first part of the first step 142, the first party 40 may submit a claim of hash shares (e.g. a Merkle tree relating to hash shares). This is useable to identify that the first party is claiming a certain amount of devoted computational power. In a second part of the first step, the first party submits proof of hash shares (e.g. a branch of the Merkle tree). In some embodiments, the second step is not always carried out. In particular, only a subset of the proofs may need to be submitted and/or proofs may only be required upon request (where typically at least a subset of proofs will be requested and/or proofs will be occasionally requested).

In a second step 144, the first party 40 places a balance of tokens in an account on the side chain 20. These tokens are a proof of stake and are typically a requirement for the first party to be eligible to participate in building a consensus or adding a block on the side chain. The tokens may be flagged as being for this purpose (and therefore withdrawal of the tokens would preclude the first party from participating in block proposing on the side chain).

Optionally, participation requires at least a minimum balance to be placed in the flagged account. Also, the flagged account may be such that a delay is enforced before a deposit and/or withdrawal can be made from the flagged account, e.g. so as to discourage parties from placing a balance in a flagged account should they not, in fact, intend to participate in block generation on the side chain 20.

While this example describes a balance being placed/deposited on the side chain 20, more generally the participation of the first party 40 may require a deposit on one or both of the main chain 10 and the side chain 20.

In a third step 146, parties (e.g. the first party 40) that have placed the required balance in a flagged account, and that wish to receive tokens when participating in generation of blocks on the side chain, obtain hash tokens. Hash tokens may be received by submitting hash shares to the SVC (as described in relation to the first step 142), or by acquiring hash tokens from another entity. This can be illustrated by considering two examples:
Where the first party 40 is devoting computational power to the main chain 10, the first party will receive hash tokens during the first step 142 of the method of FIG. 11. These hash tokens can then be used in the process of proposing a block.
Where the first party 40 is not devoting computational power to the main chain 10, the first party may receive/purchase hash tokens from another party. These received hash tokens can then be used in the process of proposing a block.

Using the hash tokens, the first party 40 is then eligible to participate in building a consensus and/or adding blocks on the side chain 20 (or to be selected as a proposer); this proposal/selection occurs in a fourth step 148.

More generally, the determination of the parameter may be based (in part) on hash tokens and/or certificates relating to the first party 40. The first party may be able to transmit hash tokens to the nodes of the main chain 10 and/or the side chain 20 so that these nodes are able to determine the parameter based on the hash tokens. This transmission may involve including the hash tokens in a block of the main chain and/or the side chain. For example, the transfer of hash shares may be recorded as a transaction in a block of the main chain and/or the side chain.

In a fifth step 150, the first party 40 receives a proposal reward, which may be distributed amongst the first party and other parties as has been explained above (e.g. with reference to FIG. 6 or 9).

There may be a market for hash tokens. Optionally, there may be a minimum number of hash tokens required to participate in block generation on the side chain (where these hash tokens relate to an activity on the main chain 10). Note that entities that wish to participate in block generation on the side chain 20 need only run SPV clients for the main chain 10, in other words, a full-copy of the main chain 10 is not required.

A commit to each block of the side chain 20 block is sent to the main chain 10 (for example, a cryptographic hash of B₂^{r} embedded within a transaction that is included in a block of the main chain 10). Any tokens earned in return for participation in generation of a block on the side chain 20 are preferably received only after a specified number of blocks have been generated on the main chain on top of the block that contains the commit. This requirement for a number of blocks to be generated reduces the risk of a double spend occurring.

Including the commit in the main chain may be the responsibility of the party that proposed B₂^{r}. If this party fails to achieve this (for example, after some set time has elapsed) the responsibility may move to another party.

In this system, the security of the side chain 20 is contingent on the security of the main chain 10 (due to the commit of the side chain block being sent to the main chain). The security of the main chain is not contingent on the security of the side chain. Miners are incentivised to add to/mine the main chain due to the requirement to obtain hash tokens relating to the main chain in order to add to/mine the side chain. Alternatively (or in addition), the reward for proposing/mining on the second chain may be dependent on the amount of hash tokens relating to the main chain 10 that are held by the proposing/mining party.

The use of hash tokens and SVCs has been described with reference to a system comprising a plurality of blockchains. It will be appreciated that hash tokens and/or SVCs may equally be implemented in a system with only a single blockchain. In particular, the first party 40 may be able to acquire from the second party 50 solutions that demonstrate a devotion of computational power. This enables the first party to boost the devoted computing power that is determined in the first step 102, 112 of the methods 100, 110 of FIGS. 4 and 5.

While the above description has considered the sharing of hash tokens, more generally parties on the blockchains 10, 20 may be able to share shares, tokens and/or certificates relating to any factor that affects the participation reward and/or the probability of being selected as a participant. As examples, parties may be able to transfer shares relating to a deposit. This may be a deposit held relating to the blockchain 10 in a single blockchain system or a deposit held relating to the main chain 10 and/or the side chain 20 in a multiple blockchain system.

In particular, parties may be motivated to delegate (e.g. transfer shares relating to) a deposit to other parties that possess large amounts of computing power.

In order to manage risk, parties with, say, a large deposit will be motivated to delegate amounts of this deposit to a diverse range of other parties. This will enable a reliable source of income (via rewards). In particular with a multi-blockchain system, this encourages parties with a substantial deposit on a proof of stake blockchain to collaborate with miners on a proof of work blockchain.

Beneficially, this offers a way to prevent the halting of the main chain 10 and/or the side chain 20. If either chain is halted (e.g. the parties on the side chain refuse to agree on the addition of further blocks), the depositors will be motivated to reallocate their deposit shares to parties that will add blocks to that chain. In particular, where the probability of being selected as a proposer and/or validator is dependent on a deposit, this reallocation of deposit shares can be used to overcome halting by altering the eligible pool of proposers and validators.

While the detailed description has primarily described the determination of a parameter based on a proof of work sybil-defence mechanism and/or a devoted computational power, it will be appreciated that many of the disclosures herein are applicable more broadly.

In general, the methods disclosed herein may be used for the ‘tokenisation’ of any sybil-defence mechanism. This is typically implemented by the determination of a parameter (e.g. an influence and/or a reward) based on a certificate held by a node, where the certificate is associated with a sybil-defence mechanism. The certificate may relate to any quantifiable resource and/or sybil-defence mechanism.

The certificate typically relates to a resource associated with a node, which resource relates to a sybil-defence mechanism (and so the certificate relates to a sybil-defence mechanism). In some embodiments, certificates may be held only by the node associated with the related resource; however, typically the certificates are tradeable so that the certificate may be transferred to another node. This enables a node that does not own the related resource to hold the certificate, so that this non-owning node is still eligible to participate in the building of a consensus for the blockchain 10.

Typically, the certificate relates to a sybil-defence mechanism that is associated with a resource that is external to the blockchain 10. Certain sybil-defence mechanisms, such as a proof of stake sybil-defence mechanism, are associated with resources that are internal to the blockchain. For example, the stake of a node can be determined by evaluating the blockchain. Therefore, certificates are not required to determine the stake of a node (though it is still possible to use certificates for this purpose). Other sybil-defence mechanisms, such as a proof of work sybil-defence mechanism, are associated with resources that are external to the blockchain so that these resources typically cannot be determined by evaluating the blockchain. Certificates provide a way in which these resources can be evidenced.

The parameter is typically dependent on a plurality of sybil-defence mechanisms. While one of these sybil-defence mechanisms is typically a proof of work sybil-defence mechanism (as described in the examples above), it will be appreciated that many of the methods disclosed herein may be applied where the sybil-defence mechanisms do not include a proof of work sybil-defence mechanism.

Dependence on a plurality of sybil-defence mechanisms may be implemented by using certificates, where these certificates enable multiple sybil-defence mechanisms to be considered simultaneously. For example, a node may receive a certificate for each solution for a proof of work problem that is submitted by that node; and the node may also receive a certificate for each unit of an asset held by that node. The certificates enable each of these sybil-defence mechanisms to be ‘tokenised’ so that the sybil-defence mechanisms can be combined in a straightforward manner. Each certificate may have a weighting, where the weighting depends on the sybil-defence mechanism, and/or the type of sybil-defence mechanism, with which the certificate is associated. This enables the impact of each sybil-defence mechanism on the blockchain 10 to be controlled by altering the weighting of the certificates. Typically, these weightings are set when the blockchain is created.

By combining the above-mentioned component parameters for each of these sybil-defence mechanisms (where the component parameters are determined based on certificates held by a node for each of the sybil-defence mechanism) a parameter may be determined that can be considered to relate to a ‘composite’ sybil-defence mechanism. This parameter for the composite sybil-defence mechanism may be used to determine the degree of the influence of the node on the consensus.

It will be appreciated that where multiple sybil-defence mechanisms are used, any combination of sybil-defence mechanisms may be used. For example, both of the sybil-defence mechanisms may be associated with a proof of deposit, and the parameter may be dependent on certificates held by a node in relation to deposits of two different tokens. Or a combination of proof of work and proof of stake may be used, as has been described above.

Exemplary sybil-defence mechanisms include:
Proof of work. The contribution of a node to a proof of work sybil-defence mechanism is typically associated with a computational power devoted by the node to the solving of a cryptographic problem.
The issuing of certificates to a node for a proof of work sybil-defence mechanism is typically dependent on a number of solutions submitted by the node to the cryptographic problem (e.g. submitting one solution may result in the issuing of one certificate).
Proof of stake. The contribution of a node to a proof of stake sybil-defence mechanism is typically associated with a token held by the node, where the token has an unstable purchasing power and/or where the token is correlated with the blockchain 10.
The issuing of certificates to a node for a proof of stake sybil-defence mechanism is typically dependent on an amount of tokens held by the node and/or a proportion of a total number of tokens that is held by the node. With a proof of stake sybil-defence mechanism, the token is typically a cryptocurrency token associated with a blockchain (e.g. the blockchain 10 and/or the side chain 20).
Proof of deposit. The contribution of a node to a proof of deposit sybil-defence mechanism is typically associated with a token held by the node, where the token maintains a stable purchasing power and/or where the token is uncorrelated with the blockchain 10. More specifically, the token is typically uncorrelated with the blockchain in that the price of the token does not substantially depend on activity on the blockchain (e.g. because the price of the token is based on an asset that is not directly associated with the blockchain).
The issuing of certificates to a node for a proof of deposit sybil-defence mechanism is typically dependent on an amount of tokens held by the node and/or a proportion of a total number of tokens that is held by the node.
With a proof of deposit sybil-defence mechanism, the token is typically a stable coin. A stable coin is a cryptocurrency that maintains stable purchasing power with respect to one or more assets, e.g. by being pegged to these assets. The assets may comprise another cryptocurrency, a fiat currency, and/or a commodity. For example, a stable coin may be pegged to a basket of goods, which basket could comprise: half a barrel of oil, 3 Ether tokens, and 12 US dollars. The assets to which a stable coin is pegged may include tokenised commodities, synthetic commodities, or more generally synthetic assets such as synthetic goods or services (where synthetic assets are blockchain-based tokens which replicate the price of an underlying good or service). A stable coin may also be pegged to one or more other stable coins.
Where a proof of deposit sybil-defence mechanism is used for the blockchain 10, this factor is typically dependent on a stable coin that is pegged to an asset that is not directly associated with the blockchain (so that, for example, a disruption to the blockchain does not affect the value of the stable coin).
Proof of burn. The contribution of a node to a proof of burn sybil-defence mechanism is typically associated with fees paid to a network by the node and/or associated with the burning of a resource.
Typically, proof of burn requires destroying/burning an asset (e.g. sending a cryptocurrency to an unspendable address).
The issuing of certificates to a node for a proof of burn sybil-defence mechanism is typically dependent on an amount of resource burnt by the node.
Proof of storage. The contribution of a node to a proof of storage sybil-defence mechanism is typically associated with an amount of digital storage associated with the node.
The issuing of certificates to a node for a proof of storage sybil-defence mechanism may be dependent on an amount of storage associated with the node.

The contribution of each node to a sybil-defence mechanism is typically determined at a regular interval (e.g. following the addition of each block to the blockchain), where certificates may then be issued (or granted) to the nodes based on their respective contributions. In practice, each node is typically required to submit evidence of their contributions to the blockchain in the form of transactions. These contributions can then be assessed based on these transactions and certificates can be issued (e.g. using a smart contract on the blockchain). The blockchain may be configured so that within each block certificates are issued to each node based on the contributions evidenced in previous blocks; these certificates may then be used to determine parameters for each of the nodes for future blocks.

Exemplary combinations of sybil-defence mechanisms on which the parameter (e.g. the influence of a node on the blockchain and/or a reward for a node) may depend include:
A proof of work sybil-defence mechanism and any other sybil-defence mechanism. As has been described throughout this document, a proof of work sybil-defence mechanism can be used to provide strong sybil-defence while the proof of stake sybil-defence mechanism ensures that the nodes of the blockchain 10 are incentivised to improve the security of the blockchain. The proof of work sybil-defence mechanism may be associated with a plurality of blockchains, whereas the proof of stake sybil-defence mechanism will typically only be associated with the blockchain 10, therefore this combination of sybil-defence mechanisms provides both strong and specific sybil-defence.
A proof of stake sybil-defence mechanism and a proof of deposit sybil defence-factor. The unstable/correlated token of the proof of stake sybil-defence mechanism may provide a comparatively strong sybil-defence effect while the provision of rewards in relation to the stable/uncorrelated token of the proof of deposit sybil-defence mechanism enables the provision of a risk-free reward.
A proof of burn sybil-defence mechanism and a proof of storage sybil-defence mechanism. The proof of storage sybil-defence mechanism encourages nodes to accrue large storage capacity, while the proof of burn sybil-defence mechanism encourages nodes to use this storage factor.
A proof of burn sybil-defence mechanism and a proof of stake sybil-defence mechanism. The proof of stake sybil-defence mechanism incentivizes nodes to hold a stake in a blockchain, while the proof of burn sybil-defence mechanism ensures that this stake is regularly burned and restocked, and is not simply hoarded.

It will be appreciated that various other combinations of sybil-defence mechanisms are possible.

Further features that may be combined with the methods, systems, and apparatuses disclosed herein (and in particular those disclosures where one of the sybil-defence factors is associated with a stable coin) are disclosed in UK application GB2108692.1 and European application EP21161346.8. These applications are incorporated here by reference.

Where a single sybil-defence mechanism is used, certificates may be used to evaluate a node over a recent, time-limited period. In particular, the certificates may each be associated with the contribution of a node to a sybil-defence mechanism over a certain period of time (and/or a certain number of blocks) and each certificate may be valid for only a certain period of time (or a certain number of blocks). Therefore, the present disclosure enables the contribution over a plurality of blocks to be considered and also enables a time-limited contribution to be considered; e.g. using certificates that expire, the contribution over only a certain number of preceding blocks can be considered.

The present disclosure includes a method of determining a parameter in dependence on a certificate held by a node (where this certificate may relate to a proof of work sybil-defence mechanism, but may equally relate to another type of sybil-defence mechanism). The present disclosure also includes a method of determining the parameter in dependence on a plurality of certificates held by a node, where the plurality of certificates relate to a plurality of different sybil-defence mechanisms.

Furthermore, the present disclosure includes a method of determining a node to which a certificate is to be issued and also a method of issuing a certificate to a node. The issuing of a certificate is based on the contribution of a node to a related sybil-defence mechanism.

Alternatives and Modifications

Various other modifications will be apparent to those skilled in the art. For example, while the detailed description has primarily related to a main chain and a side chain, it will be appreciated that the method may more generally relate to any two blockchains, where the blockchains may or may not rely on each other for security.

In order to reduce the risk of attacks on any blockchain, there may be implemented a fraud proof, for example as described in “Fraud proofs: Mustafa Al-Bassam, Alberto Sonnino, and Vitalik Buterin. Fraud proofs: Maximising light client security and scaling blockchains with dishonest majorities. arXiv preprint arXiv:1809.09044, (2018)”.

Where one of the main chain 10 and the side chain 20 uses a proof of stake mechanism, the probability of an entity being selected as participant may depend on a deposit held in relation to the other chain. As an example, where the side chain 20 uses a proof of stake mechanism, the probability of being selected as a block proposer for the side chain 20 may depend on an amount of the main chain 10 token that has been deposited. This incentivizes entities to remain active in the generation of blocks on the side chain 20, since the failure of the side chain 20 may result in the confiscation or destruction of tokens on the main chain 10.

While the detailed description has primarily considered the transfer of a digital asset, it will be appreciated that more generally ‘transactions’ may relate to the storage of any form of information. The blockchain 10, the main chain and/or the side chain 20 may for example store information relating to the behaviour of a party.

The information stored on the blockchains 10, 20 may be used to present an output to a user and/or to trigger an alarm. For example, the presence of a particular record on the blockchain may result in an alert being generated and displayed to a relevant party. Further, one or more parties may be able to view records stored on the blockchain(s), where these records may inform decisions made by those parties. As examples, the records may enable governments to enforce laws, parents to supervise the activities of their children, or companies to develop more efficient products. In general, the blockchains enable parties to take action based on recorded information, where this information is typically recorded in an immutable manner.

While the detailed description has primarily given examples with reference to Bitcoin, it will be appreciated that the disclosed systems and methods are equally applicable to other blockchain implementations, where appropriate modifications may be required to take into account differing operation codes.

While the detailed description has primarily described the methods being applied to blockchains, it will be appreciated that the methods and systems described herein may be applied to any public consensus network (PCN) and/or distributed consensus network (DCN), e.g. blockchains, graphchains, Directed Acyclic Graph (DAG), Avalanche, and the internet of things. In such embodiments, the PCN may not comprise blocks, so that where information has been described as being contained in a block or a block header, more generally such information may be included in, or contained in, a PCN.

It will be understood that the present invention has been described above purely by way of example, and modifications of detail can be made within the scope of the invention.

Reference numerals appearing in the claims are by way of illustration only and shall have no limiting effect on the scope of the claims.

1. A computer-implemented method of outputting a transmission to a second node of a blockchain, the method being performed by a first node of the blockchain, the method comprising:
determining a computational power devoted by a further node to a blockchain;
determining, based on the determined computational power, a parameter relating to:
the influence of the further node on a consensus mechanism of the blockchain; and/or
a reward for the further node; and
outputting a transmission to the second node of the blockchain in dependence on the parameter.

2. The method of claim 1, wherein the devoted computational power relates to one or more of:
a computational power devoted over a plurality of blocks of the blockchain;
an average devoted computational power and/or a moving average devoted computational power.

3. (canceled)

4. The method of claim 1, wherein the devoted computational power relates to one or more of:
an instantaneous devoted computational power;
a current devoted computational power; and
a historic devoted computational power.

5. The method of claim 1, wherein determining a parameter comprises determining a weighting for a contribution to the building of consensus for the further node.

6. The method of claim 1, wherein determining the computational power devoted to the blockchain by the further node comprises the identification of one or more proofs for a cryptographic problem.

7. The method of claim 6, wherein determining the computational power devoted to the blockchain by the further node comprises determining a difficulty of the proof(s), wherein the parameter is dependent on the difficulty.

8. The method of wherein determining the computational power devoted to the blockchain by the further node comprises one or more of:
the identification of shares held by the further node relating to the solution of a cryptographic problem;
the identification of a share verification contract (SVC);
the determination of a hash rate of the further node; and
the determination of the number of previous blocks proposed by the further node.

9. The method of claim 1, wherein the parameter is dependent on a deposit held by the further node in relation to the blockchain.

10. (canceled)

11. The method of claim 1, wherein a reward for the addition of a block to the blockchain is dependent on one or more of:
the determined parameter;
a deposit held by the further node in relation to the blockchain;
a deposit held by other nodes in relation to the blockchain;
the computational power devoted by the further node to the blockchain; and
the computational power devoted by other nodes to the blockchain.

12. The method of claim 1, wherein the parameter is dependent on two factors: the devoted computational power; and a deposit held by the further node in relation to the blockchain.

13. The method of claim 12, wherein:
the parameter is maximised when a value relating to the two factors is equal; and/or
the parameter is dependent on one or more of:
a minimum value of the two factors, and/or
a linear function relating to the two factors; and/or
the proportion of a factor held by the future node as compared to the proportion of the factor held by other nodes to the blockchain.

14. (canceled)

15. The method of claim 1, wherein the parameter is dependent on a certificate held by the further node, wherein the certificate:
is associated with the computational power devoted to the blockchain by a different node; and/or
is associated with a deposit held by a/the different node, the deposit relating to the blockchain; and/or
is transferable; and/or
has a finite lifespan; and/or
, more preferably wherein the certificate is valid for a finite number of blocks.

16. The method of claim 1, wherein the parameter is dependent on the activity of the further node on a further blockchain.

17. (canceled)

18. The method of claim 16, wherein the blockchain uses a proof of stake sybil-defence mechanism and/or the further blockchain uses a proof of work sybil-defence mechanism.

19.-28. (canceled)

29. The method of wherein claim 1, the parameter is dependent on a certificate held by the further node, wherein the certificate is associated with activity on the blockchain and/or the further blockchain of a different node.

30. (canceled)

31. The method of claim 1, wherein
determining the parameter comprises one or more of:
determining an eligibility to be selected to participate of the further node in the addition of a block to the blockchain;
determining a probability of selection to participate of the further node in the addition of a block to the blockchain;
determining a maximum degree of active participation of the further node in the addition of a block to the blockchain; and
determining a reward for the further node, the reward relating to the addition of the block to the blockchain.

32.-34. (canceled)

35. The method of claim 1, further comprising selecting the further node as a participant in the addition of the block to the blockchain.

36.-40. (canceled)

41. The method of claim 1, wherein outputting a transmission comprises one or more of:
adding a block to the blockchain;
transmitting a message to one or more nodes of the blockchain;
validating and/or signing a block of the blockchain; and
transmitting a block of the blockchain to one or more nodes of the blockchain.

42. (canceled)

43. A computer-implemented method of configuring a blockchain, such that a node of the blockchain is arranged to and/or required to:
determine a computational power devoted by a further node to a blockchain;
determine, based on the determined computational power, a parameter relating to:
the influence of the further node on a consensus mechanism of the blockchain; and/or
a reward for the further node; and
output a transmission to the second node of the blockchain in dependence on the parameter.

44. A computer-implemented method of outputting a transmission to a second node of a public consensus network, the method being performed by a first node of the public consensus network, the method comprising:
determining a computational power devoted by a further node to a public consensus network;
determining, based on the determined computational power, a parameter relating to:
the influence of the further node on a consensus mechanism of the public consensus network; and/or
a reward for the further node; and
outputting a transmission to the second node of the public consensus network in dependence on the parameter.

45.-56. (canceled)
